(19) United States
(12) Patent Application Publication
(10) Pub. No.: US 2026/0281968 A1
(43) Pub. Date: Sep. 17, 2026

(54) EXTENDING LOCATION FIX VALIDITY FOR NON-TERRESTRIAL NETWORK COMMUNICATION

(71) Applicant: QUALCOMM Incorporated, San Diego, CA (US)

(72) Inventors: Bhaskara Viswanadham BATCHU, Ameenpur Village (IN); Srikanth MENON, Bangalore (IN); Roopesh P, Telangana (IN)

(21) Appl. No.: 19/076,971

(22) Filed: Mar. 11, 2025

(51) Int. Cl. H04W 64/00; H04W 8/22; H04W 84/06

(52) U.S. Cl. CPC H04W 64/006; H04W 8/22; H04W 84/06

(57) ABSTRACT

Aspects relate to wireless communication using a non-terrestrial network. A user equipment (UE) acquires initial location information of the UE from a location fix at a first time instance and obtains, based on the initial location information of the UE and a velocity information of the UE at the first time instance, updated location information of the UE at a second time instance, without a location fix update. The UE applies, based on the updated location information, one or more link compensations to an uplink transmission of the UE directed to a non-terrestrial network (NTN) node. The NTN receives, during an established connection with the UE, at least one uplink transmission from the UE based on velocity-based link compensation and updated location information of the UE obtained without the location fix update.

### BACKGROUND

### Field of the Disclosure

The present disclosure relates generally to wireless communication systems, and, more particularly, to location fix validity of non-terrestrial network communication.

### Description of Related Art

Wireless communication systems are widely deployed to provide a range of communication services such as telephony, data transmission, messaging, multimedia streaming, broadcasting, or the like. The wireless communication systems can support multiple users by sharing system resources such as time, frequency, and power. For example, various multiple-access technologies, including Code Division Multiple Access (CDMA), Time Division Multiple Access (TDMA), Frequency Division Multiple Access (FDMA), Orthogonal Frequency Division Multiple Access (OFDMA), or the like, may be utilized to facilitate communication among multiple users. More advanced communication systems such as Long-Term Evolution (LTE) and 5G (New Radio, NR) provide enhanced capabilities for mobile broadband, massive machine-type communications (mMTC), and ultra-reliable low-latency communication (URLLC), addressing evolving demands for higher data rates, lower latency, and greater scalability.

Non-Terrestrial Networks (NTNs) are emerging components of modem wireless communication, which enable connectivity in areas (e.g., remote or geographically isolated regions) where traditional terrestrial networks may not be feasible. NTN systems operate by relaying communication signals between user equipment (UE) and core network infrastructure via non-terrestrial platforms such as satellites, high-altitude platform stations (HAPS), or high-altitude vehicles (HAVs). The integration of NTNs into 5G and beyond may facilitate broader service coverage, particularly for applications such as Internet of Things (IoT), autonomous systems, remote sensing, or similar use cases, where ubiquitous and reliable connectivity can support operations across wide areas.

In NTN, synchronization between the UE and the non-terrestrial platform contributes to maintaining reliable communication. For example, the synchronization may be facilitated by a Global Navigation Satellite System (GNSS)-fix performed by the UE. The GNSS fix provides precise timing and spatial information to compensate for propagation delays and frequency shifts caused by relative motion between the UE and the non-terrestrial platform. As both the UE and the non-terrestrial platform move through space, their relative positions change, requiring periodic updates of the GNSS fix to maintain synchronization. As communication demands increase, there are opportunities to improve connection reliability, extend communication durations, and enhance overall system performance in NTN systems.

### SUMMARY

Aspects of the disclosure provide an apparatus for wireless communication at a user equipment (UE). The apparatus includes one or more memories and one or more processors coupled to the one or more memories. The one or more processors individually or collectively configured to cause the apparatus to acquire initial location information of the UE from a location fix at a first time instance, and obtain, based on the initial location information of the UE and velocity information of the UE at the first time instance, updated location information of the UE at a second time instance, without a location fix update. The one or more processors individually or collectively further configured to cause the apparatus to apply, based on the updated location information, one or more link compensations to an uplink transmission of the UE directed to a non-terrestrial network (NTN) node.

In certain aspects of the disclosure, a method of wireless communication performed by a user equipment (UE) is provided. The method includes acquiring initial location information of the UE from a location fix at a first time instance, and obtaining, based on the initial location information of the UE and velocity information of the UE at the first time instance, updated location information of the UE at a second time instance, without a location fix update. The method further includes applying, based on the updated location information, one or more link compensations to an uplink transmission of the UE directed to a non-terrestrial network (NTN) node.

In certain aspects, a non-terrestrial network (NTN) node for wireless communication is provided. The NTN node includes one or more memories and one or more processors coupled to the one or more memories. The one or more processors individually or collectively configured to cause the NTN node to establish a connection with a non-stationary user equipment (UE) based on initial location information of the non-stationary UE. The non-stationary UE may have a velocity-based link compensation enabled, and the initial location information may be based on a location fix of the non-stationary UE. The one or more processors are individually or collectively further configured to cause the NTN node to receive, during the established connection, at least one uplink transmission from the non-stationary UE based on the velocity-based link compensation and updated location information of the non-stationary UE obtained without a location fix update.

### BRIEF DESCRIPTION OF THE DRAWINGS

Various aspects of the present disclosure are illustrated by way of example, and not limited by the appended figures, in which like references indicate similar elements:

FIG. 1 is a diagram that illustrates an example of a wireless communication system that supports non-terrestrial communication, in accordance with certain aspects of the present disclosure;

FIG. 2 is a block diagram illustrating an example network architecture that supports NTN access with transparent satellite deployment, in accordance with certain aspects of the present disclosure;

FIG. 3 is a block diagram illustrating an example network architecture that supports NTN access with regenerative satellite deployment, in accordance with certain aspects of the present disclosure;

FIG. 4 is a block diagram illustrating an example network architecture that supports NTN access with regenerative satellite deployment, in accordance with an exemplary aspect of the present disclosure;

FIG. 5 is a diagram that illustrates an example of a wireless communication system that supports velocity-based link compensation at UEs in non-terrestrial wireless communication, in accordance with an exemplary aspect of the present disclosure;

FIG. 6 is a timing diagram that illustrates an example of velocity-based compensation at a non-stationary UE, in accordance with an exemplary aspect of the present disclosure;

FIG. 7 is a process flow diagram that illustrates an example of velocity-based compensation at a non-stationary UE, in accordance with certain aspects of the present disclosure;

FIG. 8 is a block diagram that illustrates an example NTN system that supports velocity-based compensation, in accordance with certain aspects of the present disclosure;

FIG. 9 is a high-level flowchart that illustrates a method (e.g., a process) executed at a non-stationary UE for extending a location fix validity for NTN communication, in accordance with an exemplary aspect of the present disclosure;

FIG. 10 is a detailed flowchart that illustrates a method (e.g., a process) executed at a non-stationary UE to extend a location fix validity for NTN communication, in accordance with an exemplary aspect of the present disclosure;

FIG. 11 is a detailed flowchart that illustrates a method (e.g., a process) executed at a non-stationary UE that supports velocity-based compensation, in accordance with an exemplary aspect of the present disclosure;

FIG. 12 is a flowchart that illustrates a method (e.g., a process) executed at a non-stationary UE to facilitate velocity-based compensation during NTN communication, in accordance with an exemplary aspect of the present disclosure;

FIG. 13 is a high-level flowchart that illustrates a method (e.g., a process) executed at an NTN node that supports velocity-based compensation for NTN communication, in accordance with an exemplary aspect of the present disclosure; and

FIG. 14 is a detailed flowchart that illustrates a method (e.g., a process) executed at an NTN node that supports velocity-based compensation for NTN communication, in accordance with an exemplary aspect of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the disclosure will now be presented with reference to an apparatus and method. Such apparatus and method will be described in the following detailed description and illustrated in the accompanying drawings by various blocks, modules, components, circuits, steps, processes, or the like (collectively referred to as “elements”).

Accordingly, in one or more aspects, the functions described by elements of the disclosure may be implemented in hardware, software, or any combination thereof depending upon the particular application and design constraints imposed on the overall apparatus. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

At least one of a host processor, a processing core, an input/output controller, or any portion of any of such components, or any combination of such components may be implemented as a “processing system” that may include one or more processors. Examples of processors include microprocessors, microcontrollers, graphics processing units, central processing units, application processors, digital signal processors, reduced instruction set computing processors, systems on a chip, baseband processors, field programmable gate arrays, programmable logic devices, state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Non-Terrestrial Networks (NTNs) have emerged as a component of modem wireless communication, enabling connectivity in areas where traditional terrestrial networks may not be feasible. NTN systems operate by relaying communication signals between user equipment (UE) and core network infrastructure (for example, gateways or base stations) via non-terrestrial platforms such as satellites, high-altitude platform stations (HAPS), or high-altitude vehicles (HAVs). The integration of NTNs into 5G and beyond may facilitate broader service coverage, especially for applications such as Internet of Things (IoT), autonomous systems, remote sensing, or similar use cases, where ubiquitous and reliable connectivity can support operations across wide areas.

In NTN, the core network infrastructure and the non-terrestrial platform may be separated by thousands of kilometers. As a result, electromagnetic waves take time to propagate over the distance between the core network infrastructure and the non-terrestrial platform, as well as between the non-terrestrial platform and the UE. The propagation delay for NTNs may be larger than (e.g., many orders of magnitude larger than) the propagation delay encountered in terrestrial networks. Thus, synchronization between the UE and the non-terrestrial platform maintains reliable communication. The synchronization may be facilitated by a Global Navigation Satellite System (GNSS) fix (e.g., a location fix) performed by the UE. The GNSS fix provides precise timing and spatial information to compensate for the propagation delays and addresses various challenges in non-terrestrial communication, including frequency shifts due to the Doppler effect caused by relative motion between the UE and the non-terrestrial platform.

While the non-terrestrial platform is typically in motion, the UE can also experience movement, particularly in mobile or dynamic scenarios. Thus, in scenarios where both the UE and the non-terrestrial platform move through space, their relative positions change, requiring periodic updates of the GNSS fix to maintain synchronization. In some examples, a UE may not be configured for simultaneously acquiring a GNSS fix while communicating with the non-terrestrial platform (e.g., transmitting uplink data to the non-terrestrial platform and/or receiving downlink data from the non-terrestrial platform). As a result, to perform a new GNSS fix, the UE releases the connection with the non-terrestrial platform, performs GNSS fix again, and reconnects to the non-terrestrial platform. This can become challenging, especially in high-speed scenarios, and may lead to frequent disruptions in the connection. Additionally, performing GNSS fix updates consumes power, which may be a consideration for battery-driven UEs. For example, frequent GNSS fix updates may contribute to higher energy consumption, thus depleting the remaining battery power of the UE more quickly.

Certain aspects disclosed herein provide methods, circuits, and systems that are adapted to extend location fix validity for NTN communication. For example, once initial location information of a UE is acquired from a location fix (e.g., a GNSS fix) at a first time instance, updated location information of the UE at a second time instance is obtained without a location fix update. The updated location information of the UE at the second time instance may be obtained based on the initial location information of the UE and velocity information of the UE at the first time instance. Further, one or more link compensations (for example, timing advance adjustment, a Doppler adjustment, or the like) to an uplink transmission of the UE directed to an NTN node may be applied based on the updated location information. In other words, since updated location information of the UE, which is in a non-stationary mode, is obtained by utilizing the initial location information and the velocity information of the UE from the previous location fix, the requirement for frequent location fix updates may be eliminated. Thus, allowing the non-stationary UE to maintain a continuous connection with the NTN node for a longer duration, minimizing disruptions and reducing power consumption. As a result, connection reliability may be improved, battery life may be extended, and overall system efficiency may be optimized.

In further aspects, the one or more link compensations, for example, timing advance or Doppler adjustments, may be applied to the uplink transmission without releasing an established connection with the NTN node. In other words, the one or more link compensations may be applied while the UE is in a connected mode for the established connection with the NTN node. The connection with the NTN node may have been established based on the acquired initial location information from the location fix at the first time instance. Further, the velocity information of the UE and the initial location information from the location fix at the first time instance can be utilized to obtain a plurality of updated location information of the UE at a plurality of time instances after the first time instance. The plurality of time instances at which the updated location information is obtained may be periodic time instances. As a result, a duration of the established connection with the NTN node may be prolonged or extended.

In further aspects, the velocity information of the UE may be determined based on, for example, the location fix at the first time instance, motion sensor data associated with the UE at the first time instance, or a combination of the location fix and the motion sensor data at the first time instance. Once the velocity information of the UE is determined, updated location information of the UE for any subsequent time instance can be obtained if a current movement direction of the UE at the subsequent time instance is within an allowable threshold of deviation from a movement direction indicated by the determined velocity information. In other words, if the UE continues to move in substantially the same direction (for example, within the allowable threshold of deviation) as indicated by the determined velocity information, updated location information of the UE for subsequent time instances can be obtained without location fix updates. However, if at a third time instance after the first time instance, a current movement direction of the UE is outside the allowable threshold of deviation, a connection with the NTN node may be released and a location fix update may be performed at the third time instance.

In further aspects, the UE may transmit to the NTN node, a capability report indicating that a velocity-based link compensation is enabled on the UE. In an example, the velocity-based link compensation may correspond to a capability of the UE to apply the one or more link compensations to the uplink transmission based on the updated location information and without a location fix update. The capability report may further indicate the movement direction of the UE at the first time instance to the NTN node. The capability report may be transmitted in an information element of a Radio Resource Control message, a parameter in a Medium Access Control (MAC) control element, or the like.

In further aspects, the UE may select a first validity duration for the location fix at the first time instance based on the velocity-based link compensation being enabled on the UE. The selected first validity duration may be greater than a second validity duration corresponding to the velocity-based link compensation being disabled on the UE. In other words, the velocity-based link compensation when enabled on the UE may extend a validity duration of the location fix. Thus, the UE, which is in the non-stationary mode, is allowed to maintain the connection with the NTN node for a longer duration as compared to when the velocity-based link compensation is disabled. The UE may further advertise the selected first validity duration for the location fix to the NTN node. In an example, the first validity duration may be selected as “infinity”. Such a selection may allow the UE to communicate with the NTN node without releasing the established connection until the requirement of communication is over or until one or more criteria for the velocity-based link compensation are not satisfied. Examples of the one or more criteria for the velocity-based link compensation may include, but are not limited to, a current movement direction of the UE remaining within the allowable threshold of deviation from the movement direction indicated by the determined velocity information, a relative velocity between the UE and the NTN node being greater than or equal to a threshold relative velocity value, or both.

In further aspects, the NTN node may establish the connection with the UE, which is in the non-stationary mode, based on the initial location information of the UE. The initial location information may be based on the location fix of the UE, for example, at the first time instance. In a scenario where the UE has the velocity-based link compensation enabled, the NTN node may receive, during the established connection, at least one uplink transmission from the UE based on the velocity-based link compensation and the updated location information of the UE obtained without any location fix update.

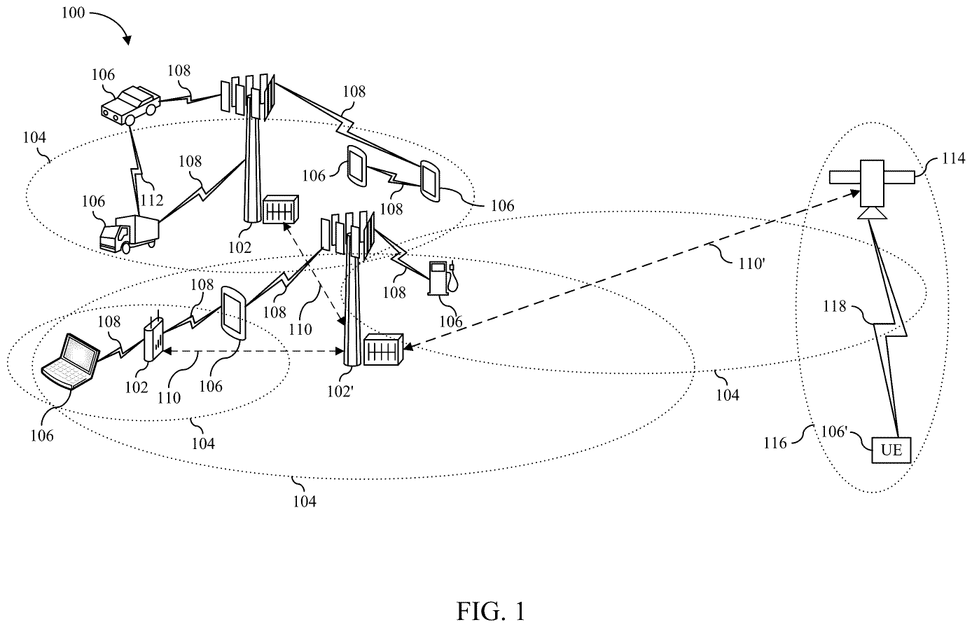

FIG. 1 is a diagram that illustrates an example of a wireless communication system 100 that supports non-terrestrial communication, in accordance with certain aspects of the present disclosure. The wireless communication system 100 may include base stations 102, which provide communication coverage for respective geographic coverage areas 104, and User Equipment (UEs) 106 that wirelessly communicates with the base stations 102 via communication links 108. In some examples, the wireless communication system 100 may be a Long Term Evolution (LTE) network, an LTE-Advanced (LTE-A) network, an LTE-A Pro network, or a New Radio (NR) network. In further examples, the wireless communication system 100 may support enhanced broadband communication, ultra-reliable (e.g., mission-critical) communication, low latency communication, or communication with low-cost and low-complexity devices.

In addition to wirelessly communicating with the UEs 106, the base stations 102 may perform, for example, transfer of user data, radio channel ciphering and deciphering, integrity protection, header compression, mobility control functions, inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages.

The base stations 102 may include or may be referred to by those skilled in the art as Node Bs, home Node Bs, evolved Node Bs (eNBs), next-generation Node Bs (gNBs), home eNBs, access points, base transceiver stations, radio base stations, radio transceivers, transceiver functions, basic service sets (BSSs), extended service sets (ESSs), transmit reception points (TRPs), millimeter wave base stations, or the like. In further aspects, some base stations 102 may be referred to as RANs and may include aggregated or disaggregated components. For example, in a disaggregated RAN, a base station may include a central unit (CU), one or more distributed units (DUs), and/or one or more remote units (RUs).

Each base station 102 may be associated with a particular geographic coverage area 104 in which communication with various UEs 106 may be supported. In other words, each base station 102 may provide communication coverage for a respective geographic coverage area 104 via the communication links 108, which may utilize one or more carriers. The geographic coverage area 104 for a base station 102 may be divided into sectors each making up a portion of the geographic coverage area 104, and each sector may be associated with a cell. For example, each base station 102 may provide communication coverage for a macrocell, a small cell, a hot spot, other types of cells, or various combinations thereof. Small cells can further include femtocells (typically used for residential or small business areas), picocells (suited for larger indoor spaces or small outdoor areas), and microcells (providing coverage in medium-sized areas such as campuses or urban zones).

The term “cell” may refer to a logical communication entity used for communication with a base station 102 (e.g., over a carrier) or a satellite beam, and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrow band Internet-of-Things (NB-IoT), enhanced mobile broadband (eMBB), or others) that may provide access for different types of devices. In some cases, the term “cell” may refer to a portion of a geographic coverage area 104 (e.g., a sector) over which the logical communication entity operates.

In some aspects, the wireless communication system 100 may be a heterogeneous network that includes the base stations 102 of different types (for example, microcell base stations and small cell base stations) providing coverage for various geographic coverage areas 104. In such aspects, the UEs 106 may communicate with various types of base stations 102 in the wireless communication system 100. In further aspects, the wireless communication system 100 may be a homogenous network that includes the base stations 102 of the same type.

In some examples, a base station 102 may be movable and therefore provide communication coverage for a moving geographic coverage area 104. In some examples, different geographic coverage areas 104 associated with different technologies may overlap and overlapping geographic coverage areas 104 associated with different technologies may be supported by the same base station 102 or by different base stations 102. In an example scenario, a base station 102, which may be a small cell base station, may have a geographic coverage area 104 that overlaps geographic coverage areas 104 of one or more other base stations 102 such as macro cell base stations.

In further aspects, a base station 102 may transmit a beamformed signal to a UE 106 in one or more transmit directions. Thus, the UE 106 may receive the beamformed signal from the base station 102 in one or more receive directions. The UE 106 may also transmit a beamformed signal to the base station 102 in one or more transmit directions. As a result, the base station 102 may receive the beamformed signal from the UE 106 in one or more receive directions. The base station 102 and/or the UE 106 may perform beam training to determine the best receive and transmit directions for each of the base station 102 and/or the UE 106. The transmit and receive directions for the base station 102 may or may not be the same. The transmit and receive directions for the UE 106 may or may not be the same.

In further aspects, the base stations 102 and the UEs 106 may each include a plurality of antennas, such as antenna elements, antenna panels, and/or antenna arrays to facilitate beamforming. Further, the communication links 108 between the base stations 102 and the UEs 106 may include uplink (also referred to as reverse link) transmissions from a UE 106 to a base station 102 and/or downlink (also referred to as forward link) transmissions from a base station 102 to a UE 106. The communication links 108 may use multiple-input and multiple-output (MIMO) antenna technology, including spatial multiplexing, beamforming, and/or transmit diversity. “Beamforming” (also referred to as spatial filtering, directional transmission, or directional reception) is a signal processing technique that may be used at a transmitting device or a receiving device (e.g., a base station 102, a UE 106, a non-terrestrial node, or the like) to shape or steer an antenna beam (e.g., a transmit beam or receive beam) along a spatial path between the transmitting device and the receiving device. Beamforming may be achieved by combining the signals communicated via antenna elements of an antenna array such that signals propagating at particular orientations with respect to an antenna array experience constructive interference while others experience destructive interference. The adjustment of signals communicated via the antenna elements may include the transmitting device or the receiving device applying certain amplitude and phase offsets to signals carried via each of the antenna elements associated with the device. The adjustments associated with each of the antenna elements may be defined by a beamforming weight set associated with a particular orientation (e.g., with respect to the antenna array of the transmitting device or the receiving device, or with respect to some other orientation).

In one or more aspects, the base stations 102 may communicate directly or indirectly (e.g., via a core network) with each other via backhaul links 110. The backhaul links 110 may be wired or wireless. In some examples, the core network may provide user authentication, access authorization, tracking, Internet Protocol (IP) connectivity, and other access, routing, or mobility functions. The core network may be an evolved packet core (EPC), which may include at least one mobility management entity (MME), at least one serving gateway (S-GW), and at least one Packet Data Network (PDN) gateway (P-GW). The MME may manage non-access stratum (e.g., control plane) functions such as mobility, authentication, and bearer management for the UEs 106 served by base stations 102 associated with the EPC. User IP packets may be transferred through the S-GW, which may be connected to the P-GW. The P-GW may provide IP address allocation as well as other functions. The P-GW may be connected to the network operator's IP services. The operator's IP services may include access to the Internet, Intranet(s), an IP Multimedia Subsystem (IMS), or a Packet-Switched (PS) Streaming Service.

The UEs 106 may be dispersed throughout the wireless communication system 100, and each UE 106 may be stationary or mobile (e.g., non-stationary). Examples of the UEs 106 may include a cellular phone, a smart phone, a session initiation protocol (SIP) phone, a laptop, a personal digital assistant (PDA), a satellite radio, a global positioning system, a multimedia device, a video device, a digital audio player (e.g., an MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 106 may be referred to as IoT devices (e.g., parking meter, gas pump, toaster, vehicles, heart monitor, etc.), Internet of Everything (IoE) devices, or the like. The UEs 106 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Further, certain UEs 106 may communicate with each other using device-to-device (D2D) communication links 112. A D2D communication link 112 may utilize the downlink/uplink wireless wide area network spectrum. Further, the D2D communication link 112 may utilize one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

In further aspects, one or more of a group of UEs 106 utilizing D2D communication may be within the geographic coverage area 104 of a base station 102. Other UEs 106 in such a group may be outside the geographic coverage area 104 of the base station 102 or be otherwise unable to receive transmissions from the base station 102. In some aspects, groups of UEs 106 communicating via D2D communication links 112 may utilize a one-to-many (1:M) system in which each UE 106 transmits to every other UE 106 in the group. In some scenarios, the base station 102 may facilitate resource scheduling for D2D communication. In other scenarios, D2D communication may be carried out between UEs 106 without the involvement of a base station 102.

In several aspects, a Non-Terrestrial Network (NTN) utilizing NTN nodes 114 may be integrated into the wireless communication system 100, such as a 5G or beyond communication system, to facilitate communication between or among a base station 102 (e.g., a base station 102′) and one or more UEs 106 (e.g., a UE 106′). An NTN may refer to a network, or a network segment, which employs airborne or spaceborne platforms/vehicles for transmission and reception. NTNs may be designed to provide wireless connectivity in unserved or underserved areas, enhancing the performance of terrestrial networks. For example, a communication satellite can cover a larger geographic region compared to a terrestrial base station. Additionally, NTNs can improve service reliability by ensuring service continuity for the UEs 106, especially non-stationary UEs, such as passenger vehicles, aircraft, ships, high-speed trains (HSTs), buses, or the like. NTNs may also enhance service availability, including critical communications, and support network scalability by offering efficient multicast or broadcast resources for data delivery at network edges or directly to the UEs 106. In some examples, the NTN may extend IoT technologies such as NB-IoT, LTE-M, and 5G RedCap (also referred to as 5G NR-Light) to enable extended satellite-based connectivity. According to 3GPP Release 17, NTNs may operate as an Evolved Universal Terrestrial Radio Access Network (E-UTRAN), including eNBs that provide IoT access to UEs through NTN nodes, with connectivity managed via NTN gateways.

In certain configurations, the base station 102′ may communicate with the UE 106′ via an NTN node 114. Examples of the NTN node 114 may include satellites, high-altitude platform stations (HAPS) such as unmanned aircraft systems (UAS), high-altitude vehicles (HAV), and similar platforms. Satellites serving as NTN nodes 114 may operate in various orbital configurations, including Low Earth Orbit (LEO), Medium Earth Orbit (MEO), Geostationary Earth Orbit (GEO), and Highly Elliptical Orbit (HEO). In some aspects, the NTN node 114 may be a transparent satellite that performs functions such as amplification, filtering, and frequency conversion. Transparent satellites may receive signals from the base station 102′ and relay the received signals to the UE 106′ using an amplify-and-forward relay technique. Similarly, the NTN node 114 may receive signals from the UE 106′ and relay the received signals to the base station 102′. The NTN node 114 can also perform carrier frequency conversion between received and transmitted signals. In other configurations, the NTN node 114 may be a non-transparent satellite capable of performing additional functions typically carried out by the base station 102′.

In some aspects, the NTN node 114 may project a beam footprint 116 that supports communication with various UEs (e.g., the UE 106′) within the beam footprint 116. The NTN node 114 may provide communication coverage for the beam footprint 116 via a communication link 118, also referred to as a service link. The communication link 118 may include uplink transmissions from the UE 106′ to the NTN node 114, or downlink transmissions from the NTN node 114 to the UE 106′. In some aspects, the NTN node 114 may have a backhaul connection 110′ (also referred to as a feeder link) with the base station 102′ such that the NTN node 114 functions as a relay station between the UE 106′ and the base station 102′. Alternatively, the NTN node 114 may act as a base station and connect directly to the core network.

In many aspects, the wireless communication system 100 may operate using one or more frequency bands, for example, an ultra-high frequency (UHF) region, a super high frequency (SHF) region, an extremely high frequency (EHF) region, or the like. Techniques disclosed herein may be employed across transmissions that use one or more different frequency regions, and designated use of bands across these frequency regions may differ by country or regulating body. In further aspects, the wireless communication system 100 may utilize both licensed and unlicensed radio frequency spectrum bands. For example, wireless communication system 100 may employ License Assisted Access (LAA), LTE-Unlicensed (LTE-U) radio access technology, or NR technology in an unlicensed band such as the 5 GHz ISM band.

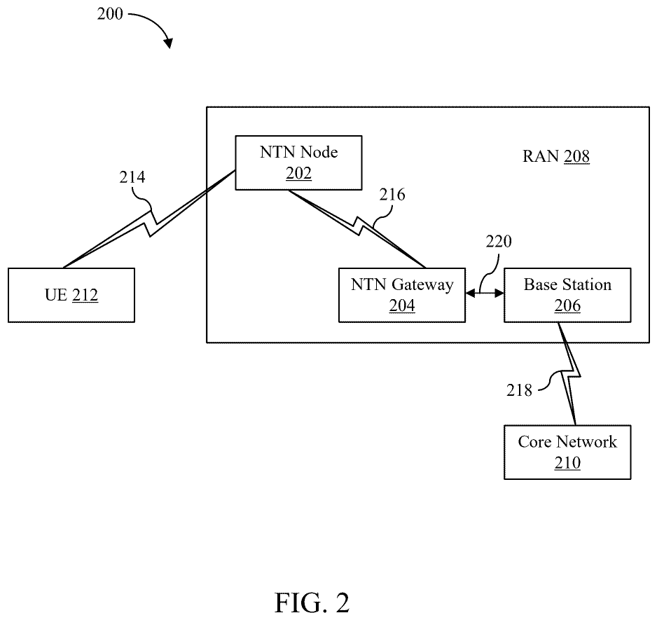

FIG. 2 is a block diagram illustrating an example network architecture 200 that supports NTN access with transparent satellite deployment, in accordance with certain aspects of the present disclosure. While aspects of FIG. 2 illustrate a 5G-based network, similar network implementations and configurations may be used for other communication technologies, such as 3G, 4G LTE, future generations of wireless communication, etc. In an example, the network architecture 200 may correspond to a transparent satellite deployment, in which an NTN node acts as a passive relay or “bent-pipe,” amplifying and forwarding signals between a UE and a ground station. In such deployments, signal processing may happen on the ground.

The network architecture 200 may include an NTN node 202, an NTN gateway 204, and a base station 206. The NTN node 202, the NTN gateway 204, and the base station 206 may be part of a RAN 208 (e.g., an NG RAN). The base station 206 may be a network node that corresponds to any of the base stations 102 (e.g., the base station 102′) of FIG. 1. Likewise, the NTN node 202 may be a network node that corresponds to the NTN node 114 of FIG. 1. The network architecture 200 may further include a core network 210 and a UE 212. The UE 212 may correspond to the UE 106′ of FIG. 1. In some aspects, the core network 210 may include a number of 5G networks including 5G Core Networks (5GCNs). The core network 210 may be a public land mobile network (PLMN). In some aspects, the core network may be 5GCNs. Various connections illustrated in the network architecture 200 may allow the base station 206 to access the NTN gateway 204 and the core network 210. In some examples, the base station 206 may be shared by multiple PLMNs. Similarly, the NTN gateway 204 may be shared by more than one base station.

FIG. 2 provides a generalized illustration of various components, any or all of which may be utilized as appropriate, and each of which may be duplicated or omitted, as necessary. Specifically, although the example of FIG. 2 includes one UE 212, it should be understood that many UEs (e.g., hundreds, thousands, millions, etc.) may utilize the network architecture 200. For example, a plurality of UEs may connect with the NTN node 202 via a plurality of service links similar to a service link 214. Similarly, the network architecture 200 may include a larger (or smaller) number of NTN nodes, NTN gateways, base stations, RANs, core networks, and/or other components. For example, as illustrated by the RAN 208, one or more RANs associated with the core network 210 may include one or more base stations. The illustrated connections that connect the various components in the network architecture 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

In many aspects, the UE 212 may be configured to communicate with the core network 210 via the NTN node 202, the NTN gateway 204, and the base station 206. In other words, network access may be provided to the UE 212 via wireless communication between the UE 212 and the base station 206 (e.g., a serving base station), via the NTN node 202 and the NTN gateway 204.

The base station 206 may provide wireless communications access to the core network 210 on behalf of the UE 212, e.g., using 5G NR. The base station 206 may transmit downlink signals to the UE 212 and receive uplink signals from the UE 212 via the NTN node 202 and the NTN gateway 204. The base station 206 may also support signaling connections and voice and data bearers to the UE 212, and may support handover of the UE 212 between different radio cells for the NTN node 202, between different NTN nodes and/or between different base stations. The base station 206 may be configured to manage moving radio beams (e.g., for airborne vehicles and/or non-geostationary “non-GEO” nodes) and associated mobility of the UE 212. The base station 206 may assist in the handover (or transfer) of the NTN node 202 between different NTN gateways or different base stations. In some examples, the base station 206 may be separate from the NTN gateway 204, e.g., as illustrated in the example of FIG. 2. In other examples, the base station 206 may include or may be combined with one or more NTN gateways, e.g., using a split architecture. For example, with a split architecture, the base station 206 may include a Central Unit (CU) and the NTN gateway 204 may include or act as a Distributed Unit (DU). In one implementation, the base station 206 may be physically combined with, or physically connected to, the NTN gateway 204 to reduce complexity and cost.

The NTN gateway 204 may be shared by more than one base station and may communicate with the UE 212 via the NTN node 202. The NTN gateway 204 may be dedicated to one associated group of NTN nodes. The NTN gateway 204 may be included within the base station 206, e.g., as a base station-DU within the base station 206. The NTN gateway 204 may communicate with the NTN node 202 using control and user plane protocols. The control and user plane protocols between the NTN gateway 204 and the NTN node 202 may manage various functions. The functions may include, for example, establishing and releasing communication links with authentication and ciphering, updating NTN node software and firmware, and performing Operations and Maintenance (O&M). The functions may further include, for example, controlling radio beams (e.g., direction, power, and status) and mapping radio beams to NTN gateway uplink and downlink payloads. Additionally, the functions may further include assisting with handovers of the NTN node 202 or radio cells to another NTN gateway.

In the illustrated example of FIG. 2, the service link 214 may facilitate communication between the UE 212 and the NTN node 202, a feeder link 216 may facilitate communication between the NTN node 202 and the NTN gateway 204, an interface link 218 may facilitate communication between the base station 206 and the core network 210, and a backhaul link 220 may facilitate communication between the base station 206 and the NTN gateway 204. The service link 214 and the feeder link 216 may be implemented by a same radio interface (e.g., the NR-Uu interface). The interface link 218 may be implemented by an NG interface. Further, the backhaul link 220 may be implemented by an NG interface, Xn interface, or the like.

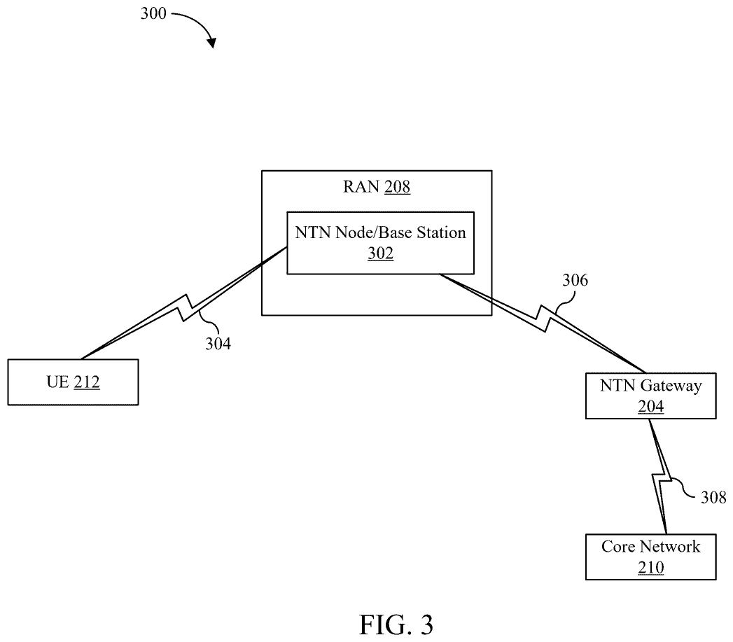

FIG. 3 is a block diagram illustrating an example network architecture 300 that supports NTN access with regenerative satellite deployment, in accordance with certain aspects of the present disclosure. While aspects of FIG. 3 illustrate a 5G-based network, similar network implementations and configurations may be used for other communication technologies, such as 3G, 4G LTE, future generations of wireless communication, etc. In an example, the network architecture 300 may correspond to a regenerative satellite deployment, in which an NTN node has on-board processing capabilities, allowing the NTN node to decode, process, and re-encode signals before transmitting to a UE.

The network architecture 300 shown in FIG. 3 may be similar to the network architecture 200 shown in FIG. 2, like designated elements being similar or the same. FIG. 3, however, illustrates an on-board base station (e.g., includes the functional capability of a base station), and is referred to herein as an NTN node/base station 302. The RAN 208 is illustrated as including the NTN node/base station 302. Reference to the NTN node/base station 302 may refer to functions related to communication with the ULE 212 and the core network 210 and/or to functions related to communication with the NTN gateway 204 and with the UE 212 at a physical radio frequency level. The NTN node/base station 302 may be a network node that corresponds to the NTN node 114 of FIG. 1.

An on-board base station may perform many of the same functions as the base station 206 as described in the foregoing description of FIG. 2. For example, the NTN node/base station 302 may transmit downlink signals to the UE 212 and receive uplink signals from the UE 212, which may include encoding and modulation of transmitted signals and demodulation and decoding of received signals. The NTN node/base station 302 may also support signaling connections and voice and data bearers to the UE 212 and may support handover of the UE 212 between different radio cells for the NTN node/base station 302 and between or among different NTN node/base stations. The NTN node/base station 302 may assist in the handover (or transfer) of the UE 212 between different NTN gateways and different control networks. The NTN node/base station 302 may hide or obscure specific aspects of the NTN node/base station 302 from the core network 210, e.g., by interfacing with the core network 210 in the same way or in a similar way to a terrestrial network base station. The NTN node/base station 302 may further assist in sharing of the NTN node/base station 302. For example. The NTN node/base station 302 may communicate with one or more NTN gateways and with one or more core networks via the NTN gateway 204. In some aspects, the NTN node/base station 302 may communicate directly with other NTN node/base stations using Inter-Satellite Links (ISLs). With low Earth orbit (LEO) devices, the NTN node/base station 302 may manage moving radio cells with coverage at different times. The NTN gateway 204 may be connected directly to the core network 210, as illustrated. The NTN gateway 204 may be shared by multiple core networks, for example, if NTN gateways are limited. In some examples the core network 210 may need to be aware of coverage area(s) of the NTN node/base station 302 in order to page the UE 212 and to manage handover.

In the illustrated example of FIG. 3, a service link 304 may facilitate communication between the UE 212 and the NTN node/base station 302, a feeder link 306 may facilitate communication between the NTN node/base station 302 and the NTN gateway 204, and an interface link 308 may facilitate communication between the NTN gateway 204 and the core network 210.

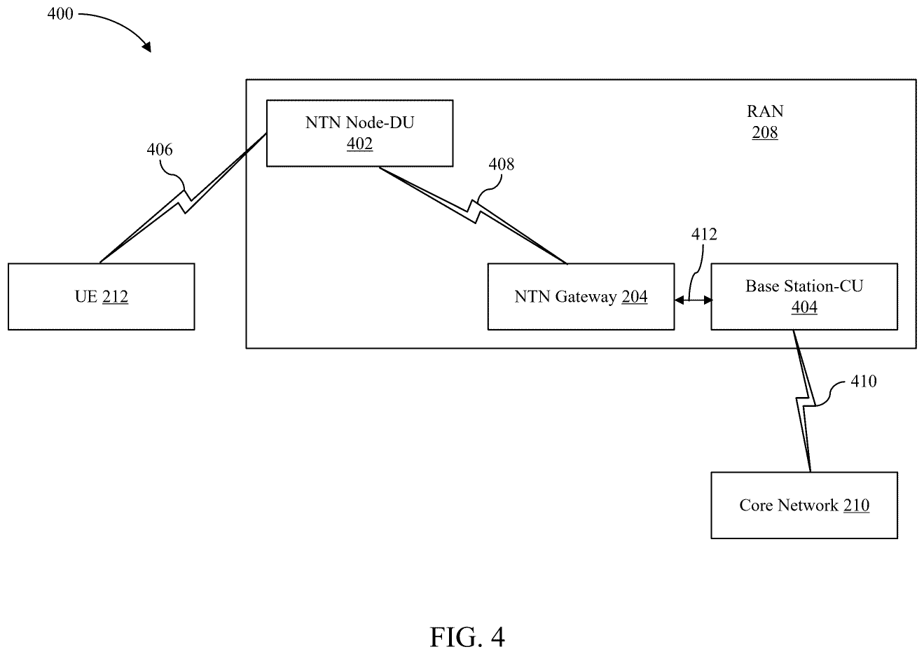

FIG. 4 is a block diagram illustrating an example network architecture 400 that supports NTN access with regenerative satellite deployment, in accordance with certain aspects of the present disclosure. While aspects of FIG. 4 illustrate a 5G-based network, similar network implementations and configurations may be used for other communication technologies, such as 3G, 4G LTE, future generations of wireless communication, etc. In an example, the network architecture 400 may correspond to a regenerative satellite deployment.

The network architecture 400 shown in FIG. 4 is similar to that shown in FIGS. 2 and 3 like designated elements being similar or the same. FIG. 4, however, illustrates a network architecture with a split architecture for the base station. For example, the base station may be split between a Central Unit (CU) and a Distributed Unit (DU). In the illustrated example of FIG. 4, the network architecture 400 may include an NTN node-DU 402, the NTN gateway 204, and a base station-CU 404. The base station-CU 404 may be a ground-based base station or a terrestrial base station. The NTN node-DU 402 may correspond to an on-board base station DU. The NTN node-DU 402 may be a network node that corresponds to the NTN node 114 of FIG. 1.

The NTN node-DU 402 may communicate with the base station-CU 404 via the NTN gateway 204. The base station-CU 404 together with the NTN node-DU 402 may perform functions, and may use internal communication protocols, which are similar to or the same as a gNB with a split architecture. In the example, the NTN node-DU 402 may correspond to and perform functions similar to or the same as a gNB Distributed Unit (gNB-DU), while the base station-CU 404 may correspond to and perform functions similar to or the same as a gNB Central Unit (gNB-CU). However, the NTN node-DU 402 and the base station-CU 404 may each include additional capability to support the UE 212 access using NTN nodes.

The NTN node-DU 402 and the base station-CU 404 may communicate with one another, for example, using an F1 Application Protocol (F1AP), and together may perform some or all of the same functions as the base station 206 or the NTN node/base station 302 as described in connection with FIGS. 2 and 3, respectively.

The NTN node-DU 402 may transmit downlink signals to the UE 212 and receive uplink signals from the UE 212, which may include encoding and modulation of transmitted signals and demodulation and decoding of received signals. The operation of the NTN node-DU 402 may be partly controlled by the base station-CU 404. The NTN node-DU 402 may support one or more NR radio cells for the UE 212. The base station-CU 404 may also be split into separate control plane (CP) (NTN-CU-CP) and user plane (UP) (NTN-CU-UP) portions. The NTN node-DU 402 and the base station-CU 404 may communicate over an F1 interface to, for example, support control plane signaling for the UE 212 and support user plane data transfer for the UE 212.

The base station-CU 404 may communicate with one or more other base station-CUs and/or with one more other terrestrial base stations using terrestrial links to support an Xn interface between any pair of base station-CUs and/or between the base station-CU 404 and any terrestrial base station.

The NTN node-DU 402 and the base station-CU 404 may support signaling connections and voice and data bearers to the UE 212, support handover of the UE 212 between different radio cells for the NTN node-DU 402 and between different NTN node-DUs; and assist in the handover (or transfer) of NTN nodes between different NTN gateways or different core networks. The base station-CU 404 may hide or obscure specific aspects of the NTN nodes from the core network 210, e.g., by interfacing to the core network 210 in the same way or in a similar way to a terrestrial network base station.

In the network architecture 400, the NTN node-DU 402 that communicates with and is accessible from a base station-CU may change over time with LEO devices. With the split base station architecture, the core network 210 may connect to base station-CUs that are fixed and that do not change over time, which may reduce difficulty with paging of the UE 212. For example, the core network 210 may not need to know which NTN node-DU is needed for paging the UE 212.

In the illustrated example of FIG. 4, a service link 406 may facilitate communication between the UE 212 and the NTN node-DU 402, a feeder link 408 may facilitate communication between the NTN node-DU 402 and the NTN gateway 204, an interface link 410 may facilitate communication between the base station-CU 404 and the core network 210, and a backhaul link 412 may facilitate communication between the base station-CU 404 and the NTN gateway 204.

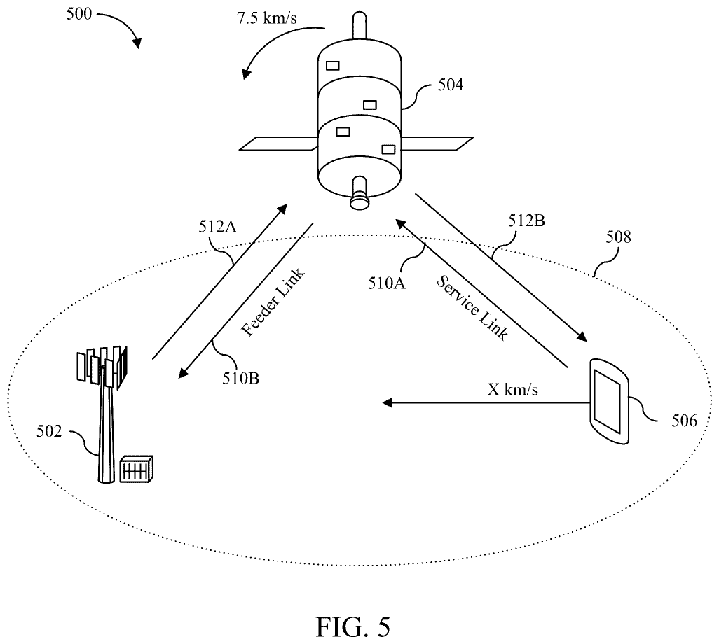

FIG. 5 is a diagram that illustrates an example of a wireless communication system 500 that supports velocity-based link compensation at UEs in non-terrestrial wireless communication, in accordance with certain aspects of the present disclosure. In some examples, the wireless communication system 500 may implement aspects of the wireless communication system 100 illustrated in FIG. 1. In further examples, the wireless communication system 500 can be implemented based on any of the network architectures 200, 300, 400 illustrated in FIGS. 2, 3, 4, respectively. As illustrated in FIG. 5, the wireless communication system 500 may include a gateway 502, an NTN node 504, and a UE 506, which may be examples of, respectively, base stations 102, an NTN node 114, and UEs 106, as described with reference to FIG. 1. The gateway 502 may serve a coverage area 508 in examples of a terrestrial network, and the NTN node 504 may serve the coverage area 508 in examples of an NTN.

In some examples, the NTN node 504 may relay communications between the gateway 502 and the UE 506. For example, the gateway 502 may communicate with the UE 506 via the NTN node 504 or vice-versa. In some examples, for communications originating at the UE 506 and directed to the gateway 502, the UE 506 may transmit an uplink transmission 510A to the NTN node 504 via a service link. The NTN node 504 may relay the uplink transmission 510A as a downlink transmission 510B to the gateway 502 via a feeder link. In further examples, for communications originating at the gateway 502 and directed to the UE 506, the gateway 502 may transmit an uplink transmission 512A to the NTN node 504 via the feeder link. The NTN node 504 may relay the uplink transmission 512A as a downlink transmission 512B to the UE 506 via the service link.

In many aspects, the service link between the UE 506 and the NTN node 504 may be established in multiple stages, starting with the UE 506 in a Radio Resource Control (RRC)_IDLE mode. In the RRC_IDLE mode, the UE 506 may be configured to listen to broadcast signals from the NTN node 504. The broadcast signals may include information such as an identity, a coverage area, and ephemeris data of the NTN node 504 through System Information Blocks (SIBs). The ephemeris data may indicate a current orbital position and a velocity (e.g., a velocity vector) of the NTN node 504, which may help the UE 506 to understand a movement trajectory of the NTN node 504.

In an example, the ephemeris data may indicate a location

$$( \begin{matrix}\to \\ {L}_{SAT}\end{matrix} )$$

of the NTN node 504 at a given epoch time (t_{epoch}) in the form of a position state vector and a velocity state vector, where the position state vector is provided as X, Y, and Z coordinates in the Earth-Centered Earth-Fixed (ECEF) reference frame and the velocity state vector is provided as V_{X}, V_{Y}, V_{Z} in the ECEF frame. The position state vector and velocity state vector may define an instantaneous spatial position and motion of the NTN node 504 relative to the Earth's surface.

In another example, the ephemeris data may indicate the location

$$( \begin{matrix}\to \\ {L}_{SAT}\end{matrix} )$$

of the NTN node 504 at the given epoch time (t_{epoch}) in the form of orbital parameters. The orbital parameters may include a semi-major axis (a) value, which specifies an average distance between the NTN node 504 and the Earth's center, and an eccentricity (e) value, which specifies a dimensionless measure of the orbit's deviation from circularity. The orbital parameters may further include an argument of periapsis (ω) value, which defines an angle between an ascending node and a point of closest approach to Earth, and a longitude of the ascending node (Ω) value, which indicates an angle from a reference direction (such as the vernal equinox) to the ascending node of the orbit. The orbital parameters may further include an inclination (i) value, which represents a tilt of the orbital plane relative to the Earth's equatorial plane, and a mean anomaly (M) value at the epoch time, which relates the position of the NTN node 504 along the orbit to the time elapsed since the NTN node 504 last passed the periapsis.

In further aspects, when the UE 506 intends to initiate communication with the NTN node 504, the UE 506 may perform, for example, a Random Access Channel (RACH) procedure. The RACH procedure may allow the UE 506 to achieve synchronization with the NTN node 504 and request radio resources for communication. Upon successful completion of the RACH procedure and establishment of the connection (e.g., the service link) between the UE 506 and the NTN node 504, the UE 506 may transition from the RRC_IDLE mode to an RRC_CONNECTED mode. In the RRC_CONNECTED mode, the UE 506 may exchange control and user data with the NTN node 504 through the uplink transmission 510A and the downlink transmission 512B on the service link. During periods of inactivity, the UE 506 may transition to an RRC_INACTIVE mode to reduce signaling overhead and conserve power while still maintaining the established connection with the NTN node 504.

In the wireless communication system 500, the NTN node 504 (for example, a satellite) may be located thousands of kilometers away from the gateway 502 and the UE 506. The distances involved in NTNs are much larger than in terrestrial networks, where distances are typically in the order of kilometers or even meters. As a result, electromagnetic waves in NTNs travel hundreds to thousands of kilometers, resulting in propagation delays that can range from several milliseconds to tens of milliseconds, depending on an altitude of the NTN node 504. For example, when the NTN node 504 is a LEO satellite at an altitude of about 500 kilometers and traveling at a speed of 7.5 km/s, a one-way propagation delay of about 2.7 milliseconds may be introduced in a signal transmission between the UE 506 and the NTN node 504. Likewise, when the NTN node 504 is a GEO satellite at an altitude of 35,786 kilometers, a one-way propagation delay of about 120 milliseconds may be introduced in a signal transmission between the UE 506 and the NTN node 504. The round trip delay in NTNs, therefore, may be significantly larger compared to terrestrial networks, where propagation delays are usually in the order of microseconds. Such extended delays can cause synchronization problems and introduce challenges, especially, for real-time communication applications.

For a stationary UE 506, the propagation delay may be a function of a location vector

$$( \begin{matrix}\to \\ {L}_{SAT}\end{matrix} )$$

of the NTN node 504, which is determined or obtained from the ephemeris data of the NTN node 504, and a location vector

$$( \begin{matrix}\to \\ {L}_{UE}\end{matrix} )$$

of the UE 506. The UE 506 may perform a location fix (e.g., a Global Navigation Satellite System “GNSS” fix) and acquire the location vector

$$( \begin{matrix}\to \\ {L}_{UE}\end{matrix} )$$

of the UE 506, which may remain constant in case of a stationary UE. In an example, the connection with the NTN node 504 may be established based on acquired location information (e.g., the location vector) of the UE 506 from the location fix.

Based on the ephemeris data and the acquired location information of the UE 506, the UE 506 may determine a distance to the NTN node 504 and estimate the propagation delay for the uplink transmission 510A. To ensure the uplink transmission 510 reaches the NTN node 504 within a correct time window or frame window (e.g., a reception window), the UE 506 may apply a timing advance (TA) adjustment to the uplink transmission 510. Applying the timing advance adjustment to the uplink transmission 510 may include adjusting a transmission timing of the uplink transmission 510 so the uplink transmission 510 aligns with the expected reception window of the NTN node 504 or the gateway 502. In an example, a timing advance adjustment value may be determined based on equation (1) shown below:

$${T}_{TA} = ( {N}_{TA} + {N}_{TA , offset} + {N}_{TA , adj}^{c o m m o n} + {N}_{TA , adj}^{UE} ) \qquad ( 1 )$$

where,
T_{TA} represents the timing advance adjustment value determined by the UE, indicating a total time adjustment to be applied to the uplink transmission 510A for synchronization with the NTN node 504,
N_{TA} represents a nominal timing advance value based on the distance of the UE 506 to the NTN node 504, N_{TA, offset} is a fixed timing advance offset that accounts for fixed delays in the NTN,

$${N}_{TA , adj}^{c o m m o n}$$

represents a network-controlled common timing advance value to compensate for a feeder link propagation delay, and

$${N}_{TA , adj}^{UE}$$

represents a UE specific timing advance value to compensate for a service link propagation delay. In an example, the

$${N}_{TA , adj}^{UE}$$

may be determined based on equation (2) as shown below:

$${N}_{TA , adj}^{U B} = 2 \times \frac{\begin{matrix}\to \\ {L}_{SAT}\end{matrix} - \begin{matrix}\to \\ {L}_{UE}\end{matrix}}{c} \qquad ( 2 )$$

where,
c represents the speed of light.

The challenges introduced by the propagation delay are further exacerbated by the relative motion between the NTN node 504 and the UE 506. For example, the NTN node 504 (e.g., a satellite) may move at high speeds relative to the Earth's surface. As a result, the distance between the NTN node 504 and the UE 506 may continuously change, causing fluctuations in the propagation delay. Additionally, such relative motion between the NTN node 504 and the UE 506 may introduce Doppler shifts in received signal frequency. Doppler shifts may occur as the relative motion between the NTN node 504 and the UE 506 causes the frequency of transmitted signal to either increase or decrease. For example, as the NTN node 504 approaches the UE 506, the frequency of the uplink transmission 510A from the UE 506 may increase. Likewise, as the NTN node 504 moves away from the UE 506, the frequency of the uplink transmission 510A from the UE 506 may decrease. The magnitude of the Doppler shift may depend on a relative velocity between the NTN node 504 and the UE 506 as well as a trajectory of the NTN node 504. To ensure the uplink transmission 510 reaches the NTN node 504 at an expected frequency, the UE 506 may apply a frequency compensation (e.g., Doppler adjustment) to the uplink transmission 510A. In an example, Doppler adjustment value (f_{d}) may be determined based on equation (3) as shown below:

$${f}_{d} = 2 {F}_{c} \times \frac{\vert \begin{matrix}\to \\ v\end{matrix} \vert cos θ}{c} \qquad ( 3 )$$

where,
F_{c} represents the frequency of light,
θ represents an angle between the relative velocity vector of the NTN node 504 and a line-of-sight (LoS) vector to the UE 506,
c represents the speed of light, and
\vec{v} represents the velocity state vector of the NTN node 504, obtained from the ephemeris data.

In other words, the UE 506 may apply one or more link compensations, such as the timing advance adjustment and the Doppler adjustment, to the uplink transmission 510A to compensate (e.g., pre-compensate) for the propagation delay and Doppler shift, respectively. As a result, the uplink transmission 510A may reach the NTN node 504 within the correct reception window and at an expected reception frequency of the NTN node 504. However, when the UE 506 is also in motion, such as in scenarios involving vehicles, aircraft, ships, or HSTs (300-500 kmph or more), both the NTN node 504 and the UE 506 may contribute to the relative motion. As illustrated in FIG. 5, the UE 506 may be moving at a speed of X km/s.

Considering that a valid location fix (e.g., GNSS fix) is needed to apply the one or more link compensations to uplink transmissions, conventionally UEs may need to perform location fix updates to acquire current UE location information and maintain synchronization with respective NTN nodes. In some examples, a UE may not be configured for simultaneously performing a location fix while communicating with an NTN node. Thus, in order to perform a location fix update, such a UE may release the established connection with the NTN node, perform a location fix again, and re-establish the connection with the NTN node. This can become challenging, especially in high-speed scenarios, and may lead to frequent disruptions in the connection. Additionally, performing location fix updates consumes power, which may be a consideration if the UE is battery-driven.

Several aspects of the present disclosure eliminate the need for location fix updates when the UE 506 is in a non-stationary mode. In such aspects, the UE 506 may perform velocity-based link compensation to maintain uplink timing and frequency synchronization with the NTN node 504 or with the gateway 502. The UE 506, in some examples, may acquire initial location information of the UE 506 from a location fix at a first time instance. In an example, the first time instance may be prior to connection establishment between the UE 506 and the NTN node 504. Once the initial location information of the UE 506 is acquired and the connection is established (for example, based on the RACH procedure), updated location information of the UE 506 at a second time instance after the first time instance may be obtained without a location fix update. The updated location information of the UE 506 at the second time instance may be obtained based on the initial location information of the UE 506 and velocity information of the UE 506 at the first time instance. In other words, various aspects of the present disclosure describe utilization of velocity information of a non-stationary UE to extend a validity duration of a location fix, and in turn extend a duration of an established NTN connection of the non-stationary UE.

Further, the UE 506 may apply the one or more link compensations (for example, the timing advance adjustment, the Doppler adjustment, or the like) to the uplink transmission 510A directed to the NTN node 504 based on the updated location information. In other words, since the updated location information of the UE 506, which is in the non-stationary mode, is obtained by utilizing the initial location information and the velocity information of the UE 506 from the location fix at the first time instance, the requirement for subsequent location fix updates may be eliminated. Thus, allowing the non-stationary UE 506 to maintain a continuous connection with the NTN node 504 for a longer duration, minimizing disruptions and reducing power consumption. As a result, connection reliability may be improved, battery life may be extended, and overall system efficiency may be optimized.

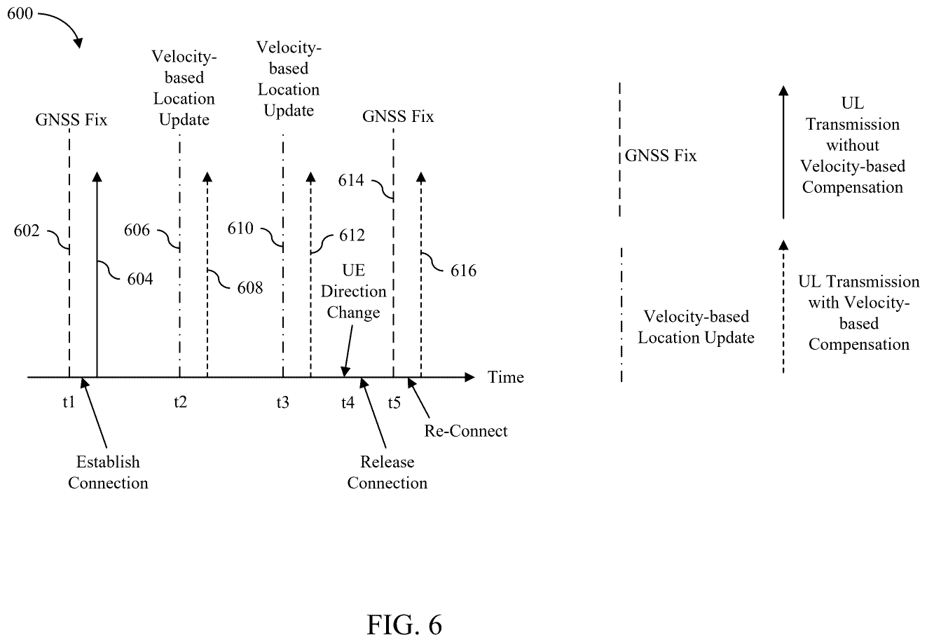

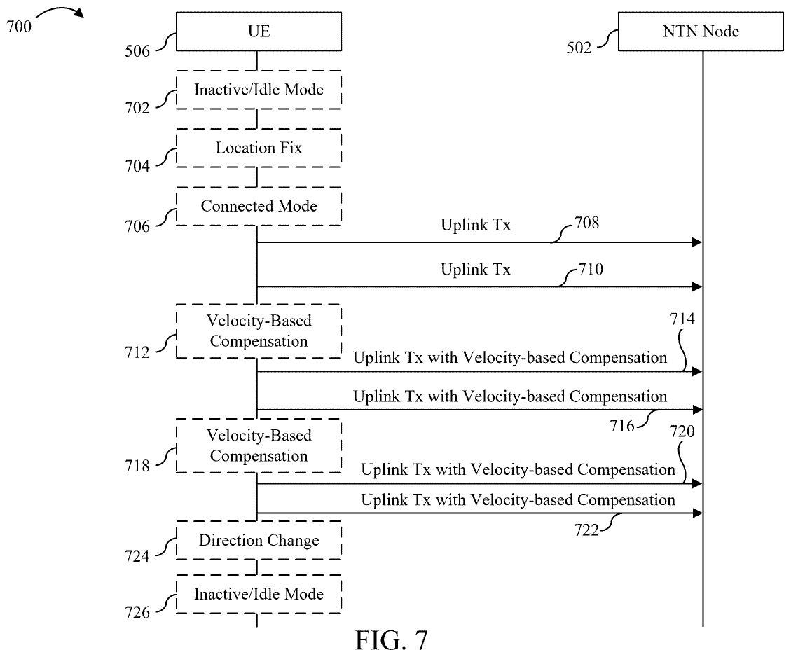

In further aspects, the NTN node 504 may establish a connection with the UE 506, which is non-stationary, based on the initial location information of the UE 506. In a scenario where the UE 506 has the velocity-based link compensation enabled, the NTN node 504 may receive, during the established connection, the uplink transmission 510A from the UE 506 based on the velocity-based link compensation and updated location information of the UE 506 obtained without a location fix update. Various aspects involved in executing the velocity-based link compensation are described in detail in conjunction with FIGS. 6 and 7.

FIG. 6 is a timing diagram 600 that illustrates an example of velocity-based compensation at a non-stationary UE, in accordance with certain aspects of the present disclosure. FIG. 6 is described in conjunction with FIGS. 1-5. Examples of the non-stationary UE may include vehicular UEs, wearable UEs, handheld devices, robotic UEs, maritime and aerial UEs, IoT devices, gaming and entertainment devices, or the like. In some examples, especially in a high-speed scenario, the non-stationary UE may move at a speed greater than or equal to 300 kmph. The non-stationary UE described in FIG. 6 may be an example of the UEs 106, 212, 506 described with reference to FIGS. 1-5.

The UE may be configured to perform a GNSS fix 602 (e.g., a location fix) at a first time instance (e.g., t1), and acquire initial location information of the UE from the GNSS fix 602 at the first time instance. In an example, the initial location information may include latitude, longitude, and altitude of the UE at the first time instance. At the first time instance, the UE may be operating in an RRC_IDLE mode. In the RRC_IDLE mode, the UE may not actively transmit data but may monitor (e.g., periodically, randomly, or when triggered) one or more broadcast channels for system information. For example, the UE may listen for SIBs transmitted by an NTN node (e.g., a satellite). The SIBs may provide details about ephemeris data, available frequency bands, network configuration, coverage area, or the like associated with the NTN node. To perform the GNSS fix 602, the UE may utilize signals from a plurality of GNSS satellites (such as Global Positioning System “GPS”, Global Navigation Satellite System “GLONASS”, etc.). In many examples, the GNSS satellites may be different from the NTN node. The NTN node described in FIG. 6 may be an example of the NTN nodes 114, 202, 504, the NTN node/base station 302, or the NTN node-DU 402 described with reference to FIGS. 1-5.

After acquiring the initial location information from the GNSS fix 602, the UE may remain in the RRC_IDLE mode and wait for an appropriate time to transition to an RRC_CONNECTED mode. The acquired initial location information from the GNSS fix 602 may then be utilized in the RACH procedure, in which the UE may attempt to establish a connection with the NTN node. In other words, the UE may establish or attempt to establish a connection with the NTN node based on the acquired initial location information from the GNSS fix 602. In an example, the RACH procedure may involve the UE transmitting a request message to the NTN node via an uplink transmission and waiting for a response from the NTN node. The request message may include a random access preamble. The NTN node can either accept or decline the request from the UE. In an aspect if the NTN node accepts the request and transmits an acceptance response to the UE, the UE may transition to the RRC_CONNECTED mode. In the example shown in FIG. 6, the NTN node accepts the request from the UE. As a result, after the first time instance, the UE may transition to the RRC_CONNECTED mode. In the RRC_CONNECTED mode, the UE may synchronize with the NTN node by estimating timing advance and Doppler adjustment values as described in the foregoing description of FIG. 5. Further, the UE may establish a connection (e.g., a service link) with the NTN node and begin data exchange with the NTN node, for example, through an uplink transmission 604 via the established connection. Further, the UE may apply one or more link compensations (e.g., the timing advance and Doppler adjustments/compensations) to the uplink transmission 604 to ensure that the uplink transmission 604 reaches the NTN node within the correct reception window and at an expected reception frequency.

In several aspects, a velocity-based link compensation may be enabled at the UE. Velocity-based link compensation may correspond to a capability of the UE to apply timing advance and Doppler adjustments to an uplink transmission directed to the NTN node based on updated location information obtained from velocity information (e.g., a velocity vector) of the UE. In other words, once the initial location information of the UE is acquired through the GNSS fix 602, and if the velocity-based link compensation is enabled at the UE, subsequent location information of the UE can be obtained based on the velocity information of the UE and the initial location information, without performing a GNSS fix update. Thus, when the velocity-based link compensation is enabled at the UE and the UE is in the non-stationary mode, the UE may be configured to determine the velocity information of the UE at the first time instance. In an example, the velocity information of a UE may indicate an instantaneous speed and a movement direction of the UE in a three-dimensional space. In other words, the velocity information of the UE may be determined in the form of a velocity vector that indicates how a location of the UE changes over time.

In some aspects, the UE may be configured to determine the velocity information based on the GNSS fix 602 at the first time instance. For example, when the UE performs the GNSS fix 602 at the first time instance, the UE may receive geographic coordinates (such as latitude, longitude, and altitude) of the UE along with the time of the GNSS fix 602. By comparing the initial location information acquired from the GNSS fix 602 with location information from a previous GNSS fix, and determining an elapsed time interval between the two GNSS fixes, the UE may determine the velocity information. The UE may compute the change in position (e.g., displacement) of the UE over the elapsed time interval, and divide the displacement by the elapsed time interval to determine the velocity information at the first time instance. The resulting velocity information may be a velocity vector that has both a magnitude (speed) and a movement direction (bearing). In some additional aspects, the UE may be configured to determine the velocity information based on motion sensor data associated with the UE at the first time instance. For example, the UE may be equipped with one or more motion sensors such as accelerometer, gyroscope, magnetometer, etc., which can either be inbuilt or externally attached. Thus, at the first time instance, the UE may be configured to acquire motion sensor data associated with the UE from the one or more motion sensors and determine the velocity information. The UE may integrate acceleration data, gyroscope data, and magnetometer data over time to determine the velocity information. In further additional aspects, the UE may determine the velocity information based on a combination of the GNSS fix 602 and the motion sensor data at the first time instance.

In further aspects, based on the velocity-based link compensation being enabled on the UE, the UE may be configured to select a first validity duration for the GNSS fix 602. The first validity duration may be greater than a second validity duration. The second validity duration may correspond to a validity duration that is utilized when the velocity-based link compensation is disabled on the UE. In an example, the UE may select “infinity” as the first validity duration for the GNSS fix 602. Such a selection may allow the GNSS fix 602 to remain valid as long as one or more validity criteria for the GNSS fix 602 are satisfied. In additional examples, the UE can select any other value that is higher than the second validity duration as the first validity duration. In further examples, the UE can select the first validity duration based on one or more parameters such as Sub Carrier Spacing (SCS) of an uplink transmission, a timing error tolerance of NTN network, a velocity of the UE, a direction of the NTN node with respect to the user velocity, or the like. In an example, the SCS may refer to the spacing between adjacent subcarriers in the frequency domain for an uplink transmission. The SCS may determine a symbol duration needed for a GNSS fix. Further, the timing error tolerance of NTN network may represent an allowable deviation in timing synchronization between the UE and the NTN node.

In several aspects, based on the velocity-based link compensation being enabled on the UE, the UE may be further configured to transmit, to the NTN node, a capability report indicating (or advertising) that the velocity-based link compensation is enabled on the UE. Further, the UE may advertise the selected first validity duration for the GNSS fix 602 to the NTN node. In some examples, transmitting the capability report may include transmitting, to the NTN node, an information element of an RRC message or a parameter in a MAC control element including the capability report. In other words, the capability report may be transmitted, to the NTN node, in an information element of the RRC message, the parameter in the Medium Access Control (MAC) control element, or the like. Examples of the RRC message may include an RRC Connection Resume Complete message, an RRC Connection Reestablishment Complete message, an RRC Connection Setup Complete message, or the like. In several additional aspects, the capability report may further indicate the movement direction of the UE at the first time instance, the velocity information of the UE, or the like to the NTN node as one of the information elements, fields, or parameters. Further, the capability report may advertise the selected first validity duration for the GNSS fix 602 to the NTN node as one of the information elements, fields, or parameters.

Since the UE is in a non-stationary mode, a location of the UE may change between the first time instance and a second time instance (t2). The second time instance may occur after the first time instance and prior to an expiration of the first validity duration. Prior to executing a velocity-based location update at the second time instance, the UE may be configured to determine whether the one or more validity criteria for the GNSS fix 602 are satisfied or not at the second time instance. The one or more validity criteria may include: a relative velocity between the UE and the NTN node at the second time instance being greater than or equal to a threshold relative velocity value, and a current movement direction of the UE at the second time instance being same or substantially same as the movement direction of the UE at the first time instance.

Thus, in some aspects, at the second time instance, the UE may be configured to determine the relative velocity between the UE and the NTN node. The UE may determine the relative velocity between the UE and the NTN node based on the determined velocity information of the UE and velocity information of the NTN node obtained from the ephemeris data of the NTN node. For example, the UE may compare a velocity vector of the UE with a velocity vector of the NTN node and determine how fast and in what direction the UE is moving relative to the NTN node. If the UE is moving in a direction that causes the UE to approach the NTN node, the relative velocity between the UE and the NTN node may be negative, indicating a decrease in distance. Conversely, if the UE is moving away from the NTN node, the relative velocity may be positive, indicating an increase in distance. Upon determining the relative velocity between the UE and the NTN node at the second time instance, the UE may compare the determined relative velocity with the threshold relative velocity value. In an aspect where, based on the comparison, the UE obtains an indication that the determined relative velocity is greater than or equal to the threshold relative velocity value, the UE may establish that the validity criteria, for the GNSS fix 602, associated with the relative velocity is satisfied at the second time instance. Alternatively, if the UE obtains an indication that the determined relative velocity is less than the threshold relative velocity value, the UE may establish that the validity criteria, for the GNSS fix 602, associated with the relative velocity is not satisfied at the second time instance.

In further aspects, at the second time instance, the UE may determine the current movement direction of the UE. The UE may determine the current movement direction based on motion sensor data generated by the one or more sensors at the second time instance. The UE may further determine whether the current movement direction of the UE is same or substantially same as the movement direction at the first time instance. The current movement direction at the second time instance may be substantially same as the movement direction at the first time instance if the current movement direction at the second time instance is within an allowable threshold of deviation from the movement direction indicated by the velocity information of the UE at the first time instance. Thus, the UE may compare the current movement direction at the second time instance with the movement direction indicated by the velocity information of the UE. In an aspect where based on the comparison, the UE obtains an indication that the current movement direction at the second time instance is within the allowable threshold of deviation, the UE may establish that the validity criteria, for the GNSS fix 602, associated with the current movement direction is satisfied at the second time instance. Alternatively, if the UE obtains an indication that the current movement direction at the second time instance is outside the allowable threshold of deviation, the UE may establish that the validity criteria, for the GNSS fix 602, associated with the current movement direction is not satisfied at the second time instance.

The allowable threshold of deviation and the threshold relative velocity value may be pre-configured parameters of the UE or defined within a communication standard. When pre-configured, the allowable threshold of deviation and the threshold relative velocity value can be set by a device manufacturer or an operator of the UE based on specific network requirements or operational conditions. Alternatively, the allowable threshold of deviation and the threshold relative velocity value may be specified as part of a communication standard, ensuring consistency and interoperability across different devices and network configurations. In an example, the threshold relative velocity value can be smaller than the timing error tolerance of the NTN network, where the timing error tolerance may be a function, such as inversely proportional, of bandwidth of an uplink signal. In a non-limiting example and for the sake of brevity, it is assumed that at the second time instance, the one or more validity criteria for the GNSS fix 602 are satisfied.

As a result, at the second time instance, the UE may execute the velocity-based location update 606. To execute the velocity-based location update 606, the UE may obtain, based on the initial location information of the UE and the velocity information of the UE at the first time instance, updated location information of the UE at the second time instance, without a GNSS fix update. In other words, based on the indications that the current movement direction of the UE is within the allowable threshold of deviation, and the determined relative velocity is less than the threshold relative velocity value, the UE may obtain the updated location information of the UE at the second time instance, without a GNSS fix update. In some examples, the UE may obtain the updated location information of the UE at the second time instance based on equations (4) and (5) as shown below:

$${V}_{UE}^{\to } ( {t}_{2} ) = ENU 2 ECEF ( {V}_{UE \_ ENU}^{\to } , {L}_{UE}^{\to } ( t 1 ) ) \qquad ( 4 )$$

$${L}_{UE}^{\to } ( t 2 ) = {L}_{UE}^{\to } ( t 1 ) + {V}_{UE}^{\to } ( {t}_{2} ) * ( {t}_{2} - {t}_{1} ) \qquad ( 5 )$$

where,
V_{\vec{UE}}(t₂) represents velocity information (e.g., a velocity vector) of the UE at the second time instance in ECEF format,
ENU2ECEF represents a function for converting ENU format to ECEF format,
L_{\vec{UE}}(t1) represents the initial location information of the UE at the first time instance,
V_{\vec{UE}_ENU} represents the velocity information of the UE at the first time instance in East-North Up (ENU) format, and
L_{\vec{UE}}(t2) represents the updated location information of the UE at the second time instance.

As shown in the equations (4) and (5) above, the UE may first obtain the velocity information of the UE at the second time instance based on the initial location information of the UE and the velocity information of the UE at the first time instance. Further, the UE obtains the updated location information of the UE at the second time instance based on the initial location information of the UE and the obtained velocity information of the UE at the second time instance. In other words, the UE may utilize the initial location information of the UE and the velocity information of the UE at the first time instance to obtain the updated location information of the UE, without GNSS fix update. The UE may be further configured to obtain a current location vector

$$( \begin{matrix}\to \\ {L}_{SAT}\end{matrix} )$$

of the NTN node at the second time instance. For example, the UE may obtain the current location vector

$$( \begin{matrix}\to \\ {L}_{SAT}\end{matrix} )$$

of the NTN node at the second time instance based on the location vector and the velocity information of the NTN node obtained from the ephemeris data of the NTN node. In an example, the UE may obtain the current location vector

$$( \begin{matrix}\to \\ {L}_{SAT}\end{matrix} )$$

of the NTN node based on equation (6) as shown below:

$${L}_{S A T}^{\to } ( t 2 ) = {L}_{S A T}^{\to } + {V}_{S A T}^{\to } ⋆ ( t 2 - {t}_{epoch} ) \qquad ( 6 )$$

where,
L_{\vec{SAT}}(t2) represents the current location vector of the NTN node at the second time instance,
L_{\vec{SAT}} represents the location vector obtained from the ephemeris data of the NTN node,
V_{\vec{SAT}} represents the velocity information obtained from the ephemeris data of the NTN node, and
t_{epoch} represents a time instance at which the ephemeris data of the NTN node is generated.

Once the updated location information of the UE and the current location vector of the NTN node at the second time instance are obtained, the UE may be further configured to estimate timing advance and Doppler adjustment values for the second time instance. In some examples, the UE may estimate the timing advance and Doppler adjustment values for the second time instance based on the updated location information of the UE and the current location vector of the NTN node (as described in the foregoing description of FIG. 5).

In an example scenario, to estimate the timing advance adjustment value for the second time instance, the UE may utilize equations (1) and (2) as described in the foregoing description of FIG. 5 but with the updated location information of the UE and the current location vector of the NTN node. Estimation of the Doppler adjustment value typically involves the use of velocity vectors of the UE and NTN node that are projected onto a unit direction vector, which represents the LoS direction between the UE and the NTN node as described in the foregoing description of FIG. 5. However, as the UE is non-stationary, the location of the UE relative to the NTN node also changes over time. Thus, the unit direction vector may no longer be constant. Therefore, the UE may be configured to determine the unit direction vector D_{\vec{UE}-SAT}(t2) at the second time instance. The unit direction vector D_{\vec{UE}-SAT}(t2) may point from the UE to the NTN node at the second time instance. The unit direction vector D_{\vec{UE}-SAT}(t2) may be obtained based on the location vector of the UE at the second time instance and the location vector of the NTN node at the second time instance. For example, the unit direction vector D_{\vec{UE}-SAT}(t2) may be obtained by using equation (7) as shown below:

$${D}_{UE - SAT}^{\to } ( t ) = \frac{{L}_{S A T}^{\to } ( t 2 ) - {L}_{UE}^{\to } ( t 2 )}{\vert {L}_{S A T}^{\to } ( t 2 ) - {L}_{UE}^{\to } ( t 2 ) \vert} \qquad ( 7 )$$

The UE may then determine a velocity of the NTN node in the direction of the determined unit direction vector and a velocity of the UE in the direction of the determined unit direction vector. For example, the velocities of the NTN node and UE in the direction of the determined unit direction vector may be determined based on equations (8) and (9) as shown below:

$${V}_{SAT} = {D}_{UE - SAT}^{\to } ( t ) \cdot {V}_{S A T}^{\to } \qquad ( 8 )$$

$${V}_{UE} = {D}_{UE - SAT}^{\to } ( t ) \cdot {V}_{UE}^{\to } \qquad ( 9 )$$

where,
V_{SAT} represents the velocity of the NTN node in the direction of the determined unit direction vector, and
V_{UE} represents the velocity of the UE in the direction of the determined unit direction vector.

The UE may further determine Doppler adjustment in parts per million (PPM), which indicates how much error is introduced in the positioning due to the relative motion between the UE and the NTN node. For example, the Doppler adjustment in PPM may be determined based on equation (10) as shown below:

$$D O {P}_{PPM} = \frac{{V}_{SAT} - {V}_{UE}}{c} \times 1 {0}^{6} \qquad ( 10 )$$

where,
DOP_{PPM} represents Doppler adjustment in PPM, and
c represents the speed of light.

Upon estimating the timing advance and Doppler adjustment values, the UE may apply one or more link compensations (e.g., timing advance and Doppler adjustments) to an uplink transmission 608 of the UE directed to the NTN node. In other words, the uplink transmission 608 corresponds to an uplink transmission to which timing advance and/or Doppler adjustments are applied based on the updated location information of the UE at the second time instance, without GNSS fix update. For example, a frequency error in the uplink transmission 608 is adjusted by subtracting twice the DOP_{PPM} from the frequency error in PPM. Thus, the UE whose location is changing is able to apply the one or more link compensations to the uplink transmission 608 while being in the RRC_CONNECTED mode for the established connection with the NTN node. In other words, the non-stationary UE is able to update corresponding location information and apply the one or more link compensations to the uplink transmission 608 without releasing the established connection with the NTN node and performing a GNSS fix update.

As the UE continues to move, a location of the UE may change again between the second time instance and a third time instance (t3). The third time instance may occur after the first time instance and prior to the expiration of the first validity duration. Thus, the UE may determine if the one or more validity criteria for the GNSS fix 602 are satisfied at the third time instance. In a non-limiting example and for the sake of brevity, it is assumed that at the third time instance, the one or more validity criteria for the GNSS fix 602 are satisfied, and thus, the UE may again execute a velocity-based location update 610 at the third time instance to obtain, based on the initial location information of the UE and the velocity information of the UE at the first time instance, updated location information of the UE at the third time instance, without a location fix update. Further, the UE may estimate the timing advance and Doppler adjustment values for the third time instance based on the updated location information of the UE at the third time instance, and apply one or more link compensations (e.g., the timing advance and/or Doppler adjustments) to a next uplink transmission 612 of the UE directed to the NTN node.

Thus, if the one or more validity criteria for the GNSS fix 602 remain satisfied, the UE may periodically obtain, based on the velocity information of the UE and the initial location information at the first time instance, a plurality of updated location information of the UE at a plurality of time instances, respectively, without the GNSS fix update. The plurality of time instances may occur after the first time instance and prior to the expiration of the first validity duration. Obtaining the plurality of updated location information may address the movement of the UE relative to the NTN node after the GNSS fix 602. In an example, the plurality of time instances may include the second time instance and the third time instance. Similarly, the plurality of updated location information may include the updated location information at the second time instance and the updated location information at the third time instance.

As the UE continues to move, a location of the UE may change again between the third time instance and a fourth time instance (t4). The fourth time instance may occur after the first time instance and prior to the expiration of the first validity duration. Thus, the UE may determine if the one or more validity criteria for the GNSS fix 602 are satisfied at the fourth time instance. In a non-limiting example and for the sake of brevity, it is assumed that at the fourth time instance, at least one of the one or more validity criteria for the GNSS fix 602 is not satisfied. For example, the UE may obtain an indication that a current movement direction of the UE at the fourth time instance is outside the allowable threshold of deviation from the movement direction indicated by the velocity information of the UE at the first time instance. In another example, the UE may obtain an indication that a relative velocity between the UE and the NTN node at the fourth time instance is less than the threshold relative velocity value. As a result, at the fourth time instance, the UE may release the connection with the NTN node based on the indication that the current movement direction of the UE at the fourth time instance is outside the allowable threshold of deviation and/or the indication that the relative velocity between the UE and the NTN node is less than the threshold relative velocity value.

Once the connection is released, the UE may perform a new GNSS fix 614 (e.g., a location fix) at a fifth time instance (e.g., t5) and acquire new location information of the UE from the new GNSS fix 614. After acquiring the new location information from the GNSS fix 614, the UE may transition to the RRC_CONNECTED mode and may attempt to re-connect with the NTN node. Once connection is re-established with the NTN node, the UE may synchronize with the NTN node and can begin the exchange of data with the NTN node, for example, through an uplink transmission 616 via the re-established connection. The uplink transmission 616 may correspond to an uplink transmission without velocity-based compensation.

An NTN deployment may be associated with long delays (e.g., a long latency and/or a long Round Trip Time “RTT”) relative to a terrestrial network due at least in part to the long distance between the UE and the NTN node. Furthermore, the delay in a transparent satellite deployment (as shown in FIG. 2) may exceed the delay in a regenerative satellite deployment (as shown in FIGS. 3 and 4) because any communication between the UE and a base station or gateway may travel from the UE to the NTN node over a service link and then from the NTN node to the base station or gateway over a feeder link, where both the service link and the feeder link may be associated with a longer delay than a terrestrial network. Accordingly, in an NTN, a UE may generally apply timing advance adjustment (e.g., a link compensation) to an uplink transmission performed in an RRC_CONNECTED mode. The timing advance adjustment may have a value that corresponds to a length of time that a signal takes to travel from the base station to the UE and back to the base station (which may be included in the NTN node in the regenerative satellite deployment or a gateway in the transparent satellite deployment). For example, the timing advance adjustment may correspond to an RTT between the base station and the UE. Similarly, the UE may apply a Doppler adjustment (e.g., another link compensation) to the uplink transmission to compensate for any Doppler shifts the uplink transmission may encounter due to the relative motion between the UE and the NTN node. In this way, the timing advance and Doppler adjustments may align the uplink transmission with the expected reception window and frequency of the NTN node or the gateway/base station.

In some aspects, the UE may perform a GNSS fix to acquire initial location information, and then utilize the acquired initial location information to estimate the timing advance and Doppler adjustments. However, if the UE is in motion, the acquired initial location information may soon become inaccurate depending upon a speed or velocity of the UE. Several aspects of the present disclosure as described in the foregoing description of FIGS. 5 and 6 enable the UE to self-update the location information based on the acquired initial location information and velocity information of the UE, without performing a new GNSS fix.

FIG. 7 is a process flow diagram 700 that illustrates an example of velocity-based compensation at a non-stationary UE, in accordance with certain aspects of the present disclosure. FIG. 7 is described in conjunction with FIGS. 1-6. The process flow diagram 700 illustrates the NTN node 504 and the UE 506 as described in the foregoing description of FIG. 5.

In many aspects, at a first time instance (shown as block 702), the UE 506 may be operating in an inactive/idle mode (for example, RRC_IDLE or RRC_INACTIVE modes). In the inactive/idle mode, the UE 506 may not actively transmit data but may listen for SIBs transmitted by the NTN node 504. The SIBs may include details about ephemeris data, available frequency bands, network configuration, coverage area, or the like associated with the NTN node 504. Further, at the first time instance, the UE 506 may perform a location fix (indicated by block 704). In an example, to perform the location fix, the UE 506 may utilize signals received from a plurality of GNSS satellites, perform multi-laceration, and acquire initial location information (latitude, longitude, and altitude) of the UE 506.

In an aspect if the NTN node 504 accepts a connection request of the UE 506, the UE 506 may transition to a connected mode (indicated by block 706). In the connected mode, the UE 506 may establish a connection (e.g., a service link) with the NTN node 504 based on the acquired initial location information from the location fix. The UE 506 may further synchronize with the NTN node 504 by estimating timing advance and Doppler adjustment values as per the acquired initial location information, and begin data exchange with the NTN node 504, for example, through one or more uplink transmissions 708, 710. The uplink transmissions 708, 710 may be pre-compensated for propagation delay and/or Doppler shift based on application of the one or more link compensations (e.g., the timing advance and Doppler adjustments) to the uplink transmissions 708, 710 by the UE 506. Thus, the NTN node 504 may receive the uplink transmissions 708, 710 within the correct reception window and at an expected reception frequency.

Since the UE 506 is in a non-stationary mode, current location of the UE 506 may constantly change. To address the location change of the UE after the location fix (indicated by block 704), the UE 506 may perform a velocity-based location update to obtain updated location information at a subsequent time instance (e.g., a second time instance) after the first time instance. The UE 506 may obtain the updated location information based on the initial location information acquired from the location fix and velocity information of the UE at the time of location fix. Obtaining the updated location information based on the initial location information and the velocity information of the UE is described in the foregoing description of FIGS. 5 and 6.

The UE 506 may then apply, based on the updated location information, one or more link compensations to one or more uplink transmissions of the UE 506 directed to the NTN node 504. The one or more link compensations that are applied based on the updated location information and without a location fix update may correspond to velocity-based compensation (indicated by block 712). Further, the uplink transmissions to which the velocity-based compensation is applied may correspond to uplink Tx with velocity-based compensation 714, 716. As can be seen in FIG. 7, the UE 506 may apply the one or more link compensations to uplink Tx 714, 716 while the UE 506 is in the connected mode for the established connection with the NTN node 504.

In many aspects, the UE 506 may need not re-estimate timing advance and doppler adjustment values for every uplink transmission. For example, the timing advance and Doppler adjustment values estimated for the uplink Tx with velocity-based compensation 714 may be reused in the uplink Tx with velocity-based compensation 716. To allow such reuse, the UE 506 may be configured to determine a timing advance update periodicity. In various aspects, the UE 506 may determine the timing advance or Doppler update periodicity based on a timing error tolerance of NTN network and a Doppler adjustment in PPM value (as described in the foregoing description of FIG. 6). Specifically, the timing advance or Doppler update periodicity may correspond to a ratio between the timing error tolerance of NTN network and the Doppler adjustment PPM value. In an example scenario, if the timing error tolerance of NTN network is 2.5 microseconds and the Doppler adjustment PPM value is 0.8 microseconds/second, the timing advance or Doppler update periodicity may be 3.125 seconds. In such scenarios, even if a periodicity of location update at the UE 506 is smaller than the timing advance or Doppler update periodicity, the UE 506 may only need to re-estimate the timing advance or Doppler adjustment values as per the determined timing advance or Doppler update periodicity.

The UE 506 may repeat velocity-based location update and velocity-based compensation (indicated by block 718) and continue to transmit uplink Tx with velocity-based compensation 720, 722 as long as one or more validity criteria for the location fix are satisfied. The one or more validity criteria may include: a relative velocity between the UE 506 and the NTN node 504 at a subsequent time instance after the first time instance of the location fix being greater than or equal to the threshold relative velocity value, and a current movement direction of the UE 506 at the subsequent time instance being same or substantially same as the movement direction of the UE 506 at the first time instance.

In some aspects, at least one of the validity criteria for the location fix may not be satisfied. For example, a current movement direction of the UE 506 may change from the movement direction of the UE 506 at the first time instance (indicated by block 724). In such aspects, the UE 506 may obtain an indication that the current movement direction of the UE 506 at the current time instance is outside the allowable threshold of deviation from the movement direction indicated by the velocity information of the UE 506 at the first time instance. As a result, the UE 506 may release the connection with the NTN node 504 and transition to the idle/inactive mode to again perform a location fix.

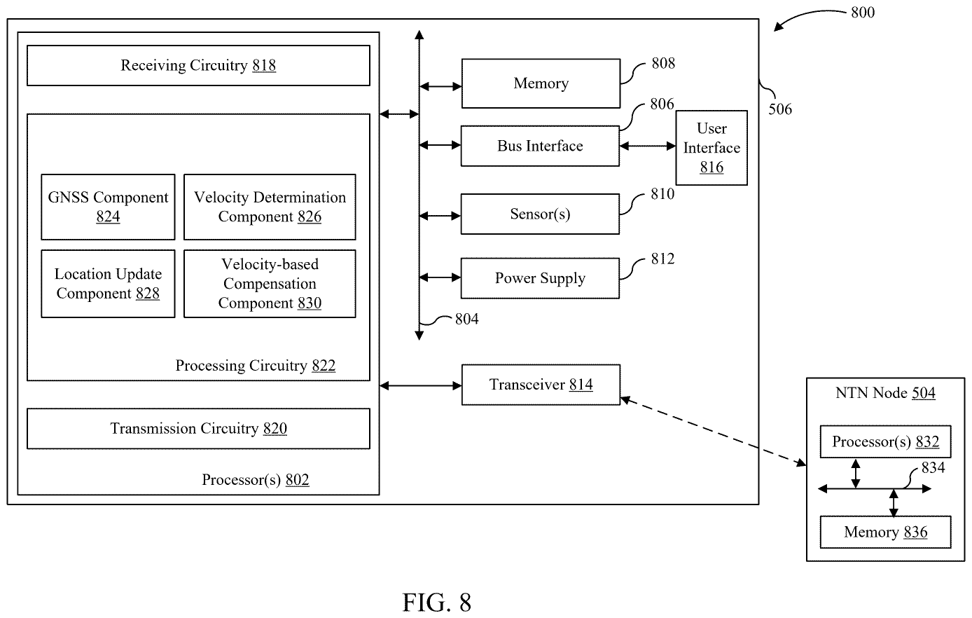

FIG. 8 is a block diagram that illustrates an example NTN system 800 that supports velocity-based compensation, in accordance with certain aspects of the present disclosure. The NTN system 800 may include various components operable, configured, or adapted to perform operations for the techniques disclosed herein, such as the operations depicted and described with respect to FIGS. 1-7. In some examples, the NTN system 800 may include the NTN node 504 and the UE 506, as described, for example with respect to FIGS. 5 and 7. In the aspects shown in FIG. 8, the UE 506 may include one or more processors 802, a bus 804, a bus interface 806, a memory 808, one or more sensors 810, a power supply 812, a transceiver 814 (e.g., a transmitter and/or a receiver).

The processor(s) 802 may include suitable circuitry, interfaces, and/or logic configured to perform one or more transmitting functions, one or more receiving functions, and one or more processing functions for the UE 506. Examples of the processing functions may include processing signals received and/or to be transmitted by the UE 506. In various aspects, the processor(s) 802 may be implemented with a bus architecture, represented generally by the bus 804. The bus 804 may include any number of interconnecting buses and bridges depending on the specific application of the processor(s) 802 and the overall design constraints. The bus 804 may provide an interface between the processor(s) 802 and the remainder of the components and devices within the UE 506. For example, the bus 804 may communicatively couple the processor(s) 802 and the memory 808. The bus 804 may also link various other circuits such as the sensor(s) 810, the power supply 812, and the transceiver 814 to the processor(s) 802. Further, the bus interface 806 may provide an interface between the bus 804 and a user interface 816. Examples of the user interface 816 may include a keypad, a display, a speaker, a microphone, a joystick, or any other input/output terminal.

The processor(s) 802 may be coupled to the memory 808 (e.g., computer-readable medium/memory) via the bus 804. The memory 808 may include suitable circuitry, interfaces, and/or logic configured to store instructions (e.g., computer-executable code) that when executed by the processor(s) 802 may cause the processor(s) 802 to perform the operations illustrated in FIGS. 1-7 and 9-12, or other operations for performing velocity-based link compensation in an NTN. The UE 506 can store data within the memory 808 by transforming the physical state of one or more physical storage units (e.g., transistors, magnetic domains, optical pits, gate cells, phase change materials, etc.) in the memory 808 to reflect the information being stored. The specific transformation of physical state can depend on various factors. Examples of such factors can include, but are not limited to, the technology used to implement the physical storage units, whether the memory 808 is characterized as primary or secondary storage, and the like. Though the memory 808 is shown to be residing in the UE 506 in FIG. 8, the scope of the disclosure is not limited to it. In additional aspects, the memory 808 can be external to the UE 506, or can be distributed across multiple entities including the UE 506.

The sensor(s) 810 may include suitable circuitry, interfaces, and/or logic configured to perform one or more sensing operations, enabling the enabling the UE 506 to gather and interpret data from corresponding environment or user interactions. In some aspects, the sensor(s) 810 may include motion sensors (such as accelerometers, gyroscopes, or magnetometers) that detect one or more motion parameters (such as movement, orientation, and rotation) of the UE 506 and generate motion sensor data to indicate the detected motion parameters. Additionally, the sensor(s) 810 may include proximity sensors, ambient light sensors, temperature sensors, biometric sensors, or the like. Collectively, the sensor(s) 810 may enable the UE 506 to provide intelligent, context-aware features that improve user experience and device performance. Although in FIG. 8 the sensor(s) 810 are shown to be integral to the UE 506, the scope of the disclosure is not limited to it. In various aspects, the sensor(s) 810 can be externally coupled to the UE 506 through the bus interface 806.

The power supply 812 may include suitable circuitry, interfaces, and/or logic configured to manage and deliver electrical power to various components of the UE 506. In an example, the power supply 812 may include a rechargeable battery, such as a lithium-ion or lithium-polymer battery. The power supply 812 may further include charging circuitry that supports wired or wires charging. The power supply 812 can further include voltage regulators and power management integrated circuits (PMICs) that supply appropriate voltage and current to the components of the UE 506. Advanced power supply 812 can also include energy-harvesting interfaces to supplement power from sources such as solar panels or kinetic energy. Furthermore, the power supply 812 may be equipped with logic to monitor and optimize battery usage.

The transceiver 814 may include suitable circuitry, interfaces, and/or logic configured to transmit (or send) and receive signals for the UE 506 via one or more antennas, enabling communication with cellular networks, Wi-Fi access points, Bluetooth devices, NTN nodes, and other wireless systems. Examples of the transmit signals may include one or more uplink transmissions to the NTN node 504 and the receive signals may include one or more downlink transmissions from the NTN node 504. Further, examples of the transceiver 814 may include, but are not limited to, cellular transceivers, Wi-Fi transceivers, Bluetooth transceivers, GNSS transceivers (such as those supporting GPS, GLONASS, or Galileo) Near Field Communication (NFC) supporting transceivers, or the like.

In some aspects, the processor(s) 802 may include circuitry configured for various functions. For example, the processor(s) 802 may include receiving circuitry 818, transmission circuitry 820, and processing circuitry 822. The receiving circuitry 818 may be configured to allow the UE 506 to receive one or more downlink signals via the transceiver 814. Likewise, the transmission circuitry 820 may be configured to allow the UE 506 to transmit one or more uplink signals via the transceiver 814. The processing circuitry 822 may be configured to perform one or more processing operations for uplink and downlink transmissions. In various aspects described in FIG. 8, the processing circuitry 822 may include a GNSS component 824, a velocity determination component 826, a location update component 828, and a velocity-based compensation component 830.

The GNSS component 824 may be configured to perform a location fix (e.g., a GNSS fix) for the UE 506 and acquire initial location information of the UE 506 based on the location fix. The GNSS component 824 may include specialized circuitry, processing logic, and algorithms to acquire the initial location information (e.g., latitude, longitude, and altitude of the UE 506) based on the time signals take to travel from GNSS satellites to the transceiver 814. In an example, the GNSS component 824 may operate in tandem with the transceiver 814, which may receive satellite signals via the antennas. The GNSS component 824 may then process the received satellite signals to perform signal correlation, timing analysis, and trilateration.

The velocity determination component 826 may be configured to determine velocity information of the UE 506. In an example, the velocity information of the UE 506 may be determined in the form of a velocity vector that has a magnitude (speed) and a movement direction (bearing). In many aspects, the velocity determination component 826 may determine the velocity information of the UE 506 based on the location fix performed by the GNSS component 824. In additional aspects, the UE 506 may determine the velocity information of the UE 506 based on motion sensor data acquired from the sensor(s) 810. In further aspects, the velocity determination component 826 may determine the velocity information of the UE 506 based on the location fix and the motion sensor data.

The location update component 828 may be configured to incorporate a hybrid positioning technique that combines the initial location information from a previous location fix and the determined velocity information at the time of previous location fix to obtain current location information of the non-stationary UE 506. In other words, the location update component 828 may enable the UE 506 to periodically or randomly update the current location information of the UE 506 without performing a new location fix. Thus, the location update component 828 may obtain a plurality of updated location information of the UE 506 to address the movement or location change of the UE 506 after the previous location fix.

The velocity-based compensation component 830 may be configured to perform velocity-based compensation in the UE 506. The velocity-based compensation, when enabled on the UE 506, may allow the UE 506 to apply velocity-based link compensation to uplink transmissions without performing location fix updates. In other words, even if a current location of the UE 506 has changed after performing the location fix, the velocity-based compensation component 830 can estimate one or more link compensations (e.g., timing advance and/or Doppler adjustment values) based on the updated location information obtained as per the initial location information and the velocity information of the UE 506, and apply the one or more link compensations to the uplink transmissions, without any update to the location fix. Further, the velocity-based compensation component 830 may select a first validity duration for the location fix based on the velocity-based link compensation being enabled on the UE 506 and advertise (or transmit) the selected first validity duration to the NTN node 504. The first validity duration may be greater than a second validity duration corresponding to the velocity-based link compensation being disabled. For example, the first validity duration can be selected as infinity.

In many aspects, in order to apply the velocity-based link compensation to an uplink transmission, the velocity-based compensation component 830 may first verify if one or more validity criteria of the previously conducted location fix are satisfied. A validity criteria for a previously conducted location fix may include a condition that the selected first validity period has not expired. Another validity criteria for a previously conducted location fix may include: a relative velocity between the UE 506 and the NTN node 504 at a current time instance being greater than or equal to a threshold relative velocity value, and a current movement direction of the UE 506 being same or substantially same as the movement direction of the UE 506 at the time of the previously conducted location fix. Thus, if at any time instance after the location fix, the velocity-based compensation component 830 obtains an indication that a current movement direction of the UE 506 is within an allowable threshold of deviation from the movement direction indicated by the velocity information and that a current relative velocity between the UE 506 and the NTN node 504 is greater than or equal to the threshold relative velocity value, the velocity-based compensation component 830 may apply the velocity-based link compensation to an uplink transmission at that time instance. However, if at any time instance after the location fix, the velocity-based compensation component 830 obtains an indication that a current movement direction of the UE 506 is outside the allowable threshold of deviation from the movement direction indicated by the velocity information and/or that a current relative velocity between the UE 506 and the NTN node 504 is less than the threshold relative velocity value, the velocity-based compensation component 830 may not apply the velocity-based link compensation but may cause the GNSS component 824 to perform a new location fix. In further aspects, when the velocity-based link compensation is enabled on the UE 506, the velocity-based compensation component 830 may transmit, to the NTN node 504, a capability report indicating that the velocity-based link compensation is enabled. In many aspects, applying the one or more link compensations to the uplink transmission may be based on the velocity-based link compensation being enabled on the UE 506.

Though FIG. 8 only illustrates various components of the UE 506, in certain aspects, the NTN node 504 may also include various hardware components such as one or more processors, a bus, a memory, one or more sensors, one or more power supply sources, one or more transceivers, or the like. For the sake of brevity, in the aspects shown in FIG. 8, the NTN node 504 is shown to include one or more processors 832, a bus 834, and a memory 836.

The processor(s) 832 may include suitable circuitry, interfaces, and/or logic configured to perform one or more transmitting functions, one or more receiving functions, and one or more processing functions for the NTN node 504. Examples of the processing functions may include processing signals received and/or to be transmitted by the NTN node 504. In various aspects, the processor(s) 832 may be implemented with a bus architecture, represented generally by the bus 834. The bus 834 may include any number of interconnecting buses and bridges depending on the specific application of the processor(s) 832 and the overall design constraints. The bus 834 may provide an interface between the processor(s) 832 and the remainder of the components and devices within the NTN node 504. For example, the bus 834 may communicatively couple the processor(s) 832 and the memory 836.

The processor(s) 832 may be coupled to the memory 836 (e.g., computer-readable medium/memory) via the bus 834. The memory 836 may include suitable circuitry, interfaces, and/or logic configured to store instructions (e.g., computer-executable code) that when executed by the processor(s) 832 may cause the processor(s) 832 to perform the operations illustrated in FIGS. 1-7 and 9-12, or other operations for performing velocity-based link compensation in an NTN. For example, the processor(s) 832 may be configured to cause the NTN node 504 to establish a connection with the UE 506, which has velocity-based link compensation enabled thereon, based on the initial location information of the UE 506. The initial location information may be based on the location fix of the UE 506. The processor(s) 832 may be further configured to cause the NTN node 504 to receive, during the established connection, at least one uplink transmission from the UE 506 based on the velocity-based link compensation and updated location information of the UE 506 obtained without a location fix update.

Examples of the processor(s) 802, 832 may include, but are not limited to system on a chip (SoC) processors, embedded processors, microcontrollers, specialized Digital Signal Processors (DSPs), Reduced Instruction Set Computing (RISC) processors, Application-Specific Integrated Circuit (ASIC) processors, field-programmable gate arrays (FPGAs), central processing units (CPUs), explicitly parallel instruction computing (EPIC) processors, very long instruction word (VLIW) processors, programmable logic devices (PLDs), state machines, gated logic, discrete hardware circuits, and other suitable processors or circuits configured to perform the various functionality described throughout this disclosure. In further aspects, the processor(s) 802, 832 may be implemented via a baseband or modem chip and in additional implementations, the processor(s) 802, 832 may comprise a number of devices distinct and different from a baseband or modem chip.

In various aspects, the processor(s) 802, 832 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In many aspects, the memories 808, 836 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer.

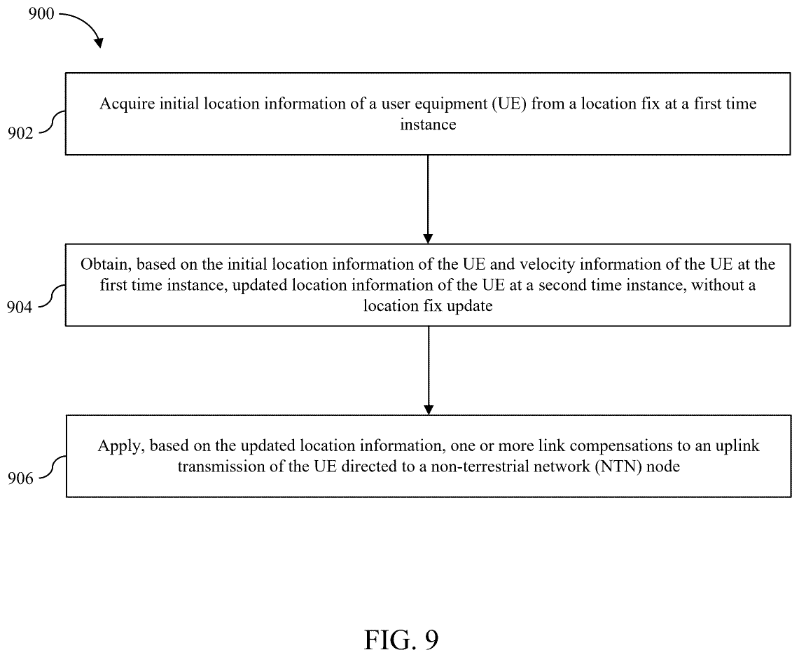

FIG. 9 is a high-level flowchart that illustrates a method (e.g., a process) executed at a non-stationary UE for extending a location fix validity for NTN communication, in accordance with an exemplary aspect of the present disclosure. In many examples, the non-stationary UE can be the UE 106′, the UE 212, or the UE 506 described in the foregoing description of FIGS. 1-8. Referring to FIG. 9, there is shown a flowchart 900 that illustrates exemplary operations 902 through 906 for extending the location fix validity for NTN communication by applying velocity-based link compensations. In a non-limiting example, the flowchart 900 is explained with reference to the UE 506 and the NTN node 504 of FIGS. 5-8.

At 902, initial location information of a UE is acquired from a location fix at a first time instance. For example, the UE 506 may perform the location fix, such as a GNSS fix, at the first time instance and acquire the initial location information of the UE 506 from the location fix at the first time instance. The initial location information may include a location vector of the UE 506, indicating a latitude, longitude, and altitude of the UE 506 at the first time instance. In many aspects, the UE 506 may be in a non-stationary mode. In various examples of a high-speed scenario, the UE 506 may move at a speed greater than or equal to 300 kmph. In various examples of a non-high-speed scenario, the UE 506 may move at a speed of less than 300 kmph.

At 904, updated location information of the UE at a second time instance, without a location fix update, may be obtained based on the initial location information of the UE and velocity information of the UE at the first time instance. For example, the UE 506 may obtain the updated location information of the UE 506 at the second time instance based on the initial location information of the UE 506 from the location fix and the velocity information of the UE 506 at the first time instance. In many examples, the second time instance may be after the first time instance. By obtaining the updated location information, the UE 506 may address the location changes between the first time instance and the second time instance.

At 906, based on the updated location information, one or more link compensations may be applied to an uplink transmission of the UE directed to an NTN node. For example, the UE 506 may apply the one or more link compensations to the uplink transmission directed to the NTN node 504 based on the updated location information. More specifically, the UE 506 may apply the one or more link compensations to the uplink transmission directed to the NTN node 504 using one or more adjustment values estimated based on the updated location information. In an example, the UE 506 may be communicatively coupled to the NTN node 504 and may direct the uplink transmission to the NTN node 504. The UE 506 may apply the one or more link compensations (for example, a timing advance adjustment and/or a Doppler adjustment) to the uplink transmission to align the uplink transmission with an expected reception window and an expected frequency of the NTN node 504.

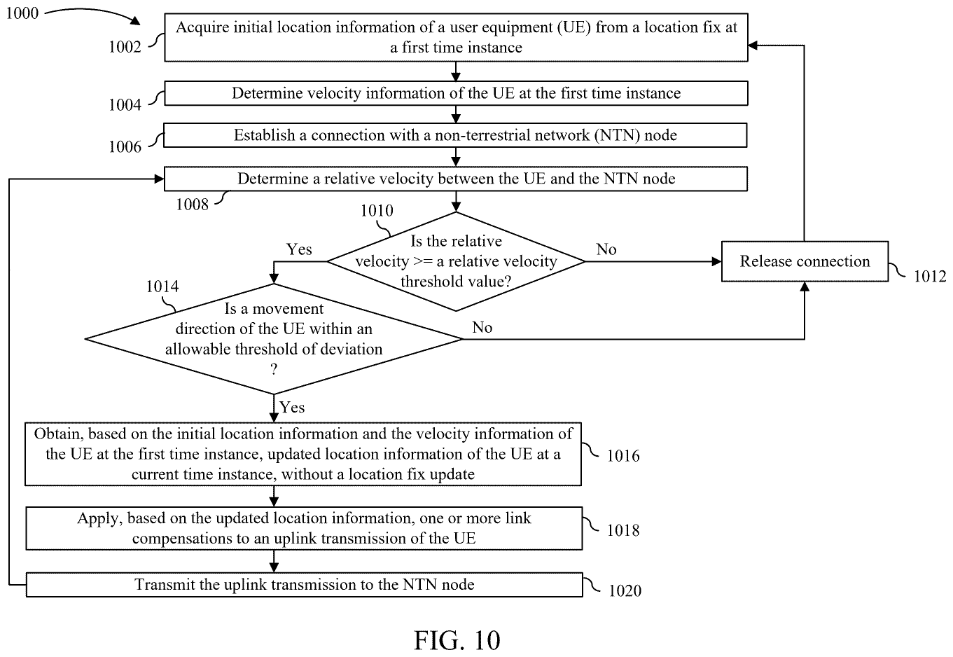

FIG. 10 is a detailed flowchart that illustrates a method (e.g., a process) executed at a non-stationary UE to extend a location fix validity for NTN communication, in accordance with an exemplary aspect of the present disclosure. In many examples, the non-stationary UE can be the UE 106′, the UE 212, or the UE 506 described in the foregoing description of FIGS. 1-8. Referring to FIG. 10, there is shown a flowchart 1000 that illustrates exemplary operations 1002 through 1020 for extending the location fix validity for NTN communication by applying velocity-based link compensations. In a non-limiting example, the flowchart 1000 is explained with reference to the UE 506 and the NTN node 504 of FIGS. 5-8.

At 1002, initial location information of a UE is acquired from a location fix at a first time instance. For example, the UE 506 may perform the location fix, such as a GNSS fix, at the first time instance and acquire the initial location information of the UE 506. In many aspects, the UE 506 may be in a non-stationary mode.

At 1004, velocity information of the UE at the first time instance may be determined. In some aspects, the UE 506, which is in a non-stationary mode, may determine the velocity information based on the location fix at the first time instance, motion sensor data associated with the UE 506 at the first time instance, or both. Determination of the velocity information is described in detail in the foregoing description of FIG. 5. In many aspects, the velocity information may indicate both a magnitude (speed) and a movement direction (bearing) of the UE 506.

At 1006, a connection with an NTN node may be established. The UE 506 may be configured to establish the connection (e.g., a service link) with the NTN node 504 based on the acquired initial location information from the location fix. For example, the UE 506 may establish the connection with the NTN node 504 by implementing the RACH procedure. In some aspects, upon successful completion of the RACH procedure and establishment of the connection between the UE 506 and the NTN node 504, the UE 506 may transition from an RRC_IDLE mode to an RRC_CONNECTED mode.

At 1008, a relative velocity between the UE and the NTN node may be determined. The UE 506 may determine the relative velocity between the UE 506 and the NTN node 504 at a current time instance after the first time instance. The UE 506 may determine the relative velocity between the UE 506 and the NTN node 504 based on the determined velocity information of the UE 506 and velocity information of the NTN node 504. For example, the UE 506 may compare a determined velocity vector of the UE 506 with a velocity vector of the NTN node 504 and determine how fast and in what direction the UE 506 is moving relative to the NTN node 504. If the UE 506 is moving in a direction that causes the UE 506 to approach the NTN node 504, the relative velocity between the UE 506 and the NTN node 504 may be negative, indicating a decrease in distance. Conversely, if the UE 506 is moving away from the NTN node 504, the relative velocity may be positive, indicating an increase in distance. At 1010, the UE 506 may determine whether the relative velocity is greater than or equal to a relative velocity threshold value. For example, the UE 506 may compare the determined relative velocity with the relative velocity threshold value and a result of the comparison may indicate whether the relative velocity is greater than or equal to the relative velocity threshold value or not.

If the UE 506 determines that the relative velocity between the UE 506 and the NTN node 504 is less than the relative velocity threshold value, at 1012, the UE 506 may release the connection with the NTN node 504 and proceed to 1002. For example, the UE 506 may trigger a radio link failure (RLF) procedure to release the connection with the NTN node 504. The ULE 506 may release the connection with the NTN node 504 to re-acquire latest location information of the UE 506 by performing a new location fix.

However, if the UE 506 determines that the relative velocity between the UE 506 and the NTN node 504 is greater than or equal to the relative velocity threshold value, at 1014, the UE 506 may determine whether a movement direction of the UE 506 is within an allowable threshold of deviation. In other words, the UE 506 may compare the movement direction of the UE 506 at the current time instance with the movement direction indicated by the determined velocity information of the UE 506 at the first time instance to check if the movement direction at the current time instance is same or substantially same as the movement direction at the first time instance. If the UE 506 determines that the movement direction at the current time instance is outside the allowable threshold of deviation from the movement direction at the first time instance, control may proceed to 1012. Thus, the UE 506 may release the connection with the NTN node 504 and proceed to 1002.

However, if the UE 506 determines that the movement direction at the current time instance is within the allowable threshold of deviation from the movement direction at the first time instance, at 1016, based on the initial location information and the velocity information of the UE at the first time instance, updated location information of the UE at the current time instance is obtained without a location fix update. In other words, the UE 506 may utilize the initial location information and the velocity information of the UE 506 at the first time instance to self-update the current location of the UE 506 without performing the location fix update.

At 1018, based on the updated location information, one or more link compensations may be applied to an uplink transmission of the UE. For example, the UE 506 may be communicatively coupled to the NTN node 504 and may intend to direct the uplink transmission to the NTN node 504. To compensate for propagation delay and Doppler shift in the uplink transmission, the UE 506 may apply the one or more link compensations (for example, a timing advance adjustment and/or a Doppler adjustment) to the uplink transmission and align the uplink transmission with an expected reception window and an expected frequency of the NTN node 504. In other words, the UE 506 may apply the one or more link compensations to the uplink transmission while the UE 506 is in a connected mode (e.g., an RRC_CONNECTED mode) for the established connection with the NTN node 504. Timing advance and Doppler adjustment values for the current time instance may be estimated based on the updated location information of the UE 506. At 1020, the uplink transmission may be transmitted to the NTN node. For example, the UE 506 may transmit the uplink transmission, which is pre-compensated for propagation delay and Doppler shift by applying the one or more link compensations, to the NTN node 504.

Thus, the UE 506 may periodically obtain, based on the determined velocity information of the UE 506 and the initial location information at the first time instance, a plurality of updated location information of the UE 506 at a plurality of time instances, respectively, without the location fix update. The plurality of time instances may occur after the first time instance at which the location fix was performed, and the plurality of updated location information may include updated location information obtained at any of the plurality of time instances.

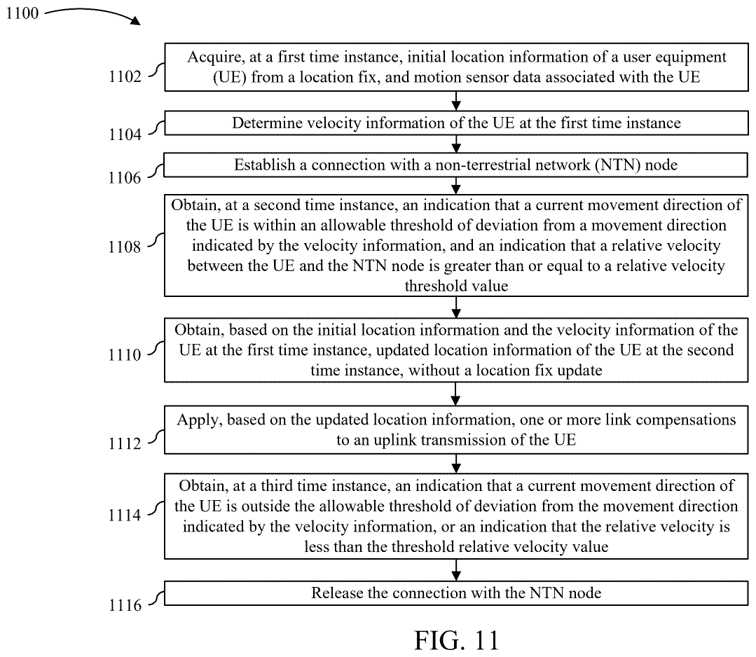

FIG. 11 is a flowchart that illustrates a method (e.g., a process) executed at a non-stationary UE that supports velocity-based compensation, in accordance with an exemplary aspect of the present disclosure. In many examples, the non-stationary UE can be the UE 106′, the UE 212, or the UE 506 described in the foregoing description of FIGS. 1-8. Referring to FIG. 11, there is shown a flowchart 1100 that illustrates exemplary operations 1102 through 1116 for extending the location fix validity for NTN communication by applying velocity-based link compensations. In a non-limiting example, the flowchart 1100 is explained with reference to the UE 506 and the NTN node 504 of FIGS. 5-8.

At 1102, initial location information of a UE from a location fix and motion sensor data associated with the UE may be acquired at a first time instance. For example, the UE 506 may perform the location fix, such as a GNSS fix, at the first time instance and acquire the initial location information of the UE 506. In many aspects, the UE 506 may be in a non-stationary mode and acquire the motion sensor data from one or more motion sensors associated with the UE 506.

At 1104, velocity information of the UE at the first time instance may be determined. In some aspects, the UE 506 may determine the velocity information based on the location fix at the first time instance, the motion sensor data associated with the UE 506 at the first time instance, or both. For example, when the UE 506 performs the location fix at the first time instance, the UE 506 may receive timestamped geographic coordinates (e.g., initial location information) of the UE 506 and compare the timestamped geographic coordinates acquired from the location fix with timestamped geographic coordinates from a previous location fix. Based on the comparison, the UE 506 may determine an elapsed time interval between the two location fixes. The UE 506 may then compute the change in position (e.g., displacement) of the UE 506 over the elapsed time interval. Based on the computed displacement and the determined elapsed time interval, the UE 506 may determine the velocity information at the first time instance. In some additional examples, the UE 506 may integrate the acquired motion sensor data such as acceleration data, gyroscope data, and magnetometer data over time to determine the velocity information of the UE 506.

At 1106, a connection with an NTN node may be established. The UE 506 may establish the connection with the NTN node 504 based on the acquired initial location information from the location fix. Upon successful establishment of the connection between the UE 506 and the NTN node 504, the UE 506 may transition from an RRC_IDLE mode to an RRC_CONNECTED mode.

At 1108, at a second time instance, an indication that a current movement direction of the UE is within an allowable threshold of deviation from a movement direction indicated by the velocity information, and an indication that a relative velocity between the UE and the NTN node is greater than or equal to a relative velocity threshold value may be obtained. The second time instance may be after the first time instance. For example, the UE 506 may compare the relative velocity between the UE 506 and the NTN node 504 at the second time instance with the threshold relative velocity value to check if the location fix at the first time instance is still valid or not. Similarly, the UE 506 may compare the current movement direction of the UE 506 at the second time instance with the movement direction indicated by the velocity information at the first time instance to check if the location fix at the first time instance is still valid or not. The location fix at the first time instance may be considered valid when the indication that the current movement direction of the UE is within the allowable threshold of deviation, and the indication that the relative velocity between the UE and the NTN node at the second time instance is greater than or equal to the relative velocity threshold value are obtained.

At 1110, based on the initial location information and the velocity information of the UE at the first time instance, updated location information of the UE at the second time instance, without a location fix update, may be obtained. In other words, the UE 506 may utilize the initial location information and the velocity information of the UE 506 at the first time instance to self-update the location information of the UE 506 at the second time instance without performing the location fix update. Thus, the UE 506 may periodically obtain, based on the velocity information of the UE 506 and the initial location information at the first time instance, a plurality of updated location information of the UE 506 at a plurality of time instances, respectively, without the location fix update. The plurality of time instances may occur after the first time instance and include the second time instance. Further, the plurality of updated location information may include the updated location information at the second time instance.

At 1112, based on the updated location information, one or more link compensations may be applied to an uplink transmission of the UE. For example, the UE 506 may apply a timing advance adjustment and/or a Doppler adjustment (e.g., the one or more link compensations) to the uplink transmission directed to the NTN node 504. In other words, obtaining the updated location information at the second time instance and applying the one or more link compensations to the uplink transmission may be based on the indications that the relative velocity between the UE 506 and the NTN node 504 is greater than or equal to the threshold relative velocity value and the current movement direction of the UE 506 is within the allowable threshold of deviation. In many aspects, the UE 506 may apply the one or more link compensations to the uplink transmission while the UE 506 is in a connected mode for the established connection with the NTN node 504. In other words, between the first time instance and the second time instance, the UE 506 may not need to release the connection with the NTN node 504 due to changing location of the UE 506.

At 1114, at a third time instance, an indication that a current movement direction of the UE is outside the allowable threshold of deviation from the movement direction indicated by the velocity information, or an indication that the relative velocity is less than the threshold relative velocity value may be obtained. The third time instance may be after the first time instance and the second time instance. In a scenario where the UE 506 obtains the indication that the current movement direction of the UE 506 is outside the allowable threshold of deviation from the movement direction indicated by the velocity information at the first time instance, or that the relative velocity between the UE 506 and the NTN node 504 at the third time instance is less than the threshold relative velocity value, the UE 506 may consider that the location fix at the first time instance is no longer valid. Thus, at 1116, the connection with the NTN node may be released. For example, based on the indication(s) at the third time instance, the UE 506 may trigger an RLF procedure to release the connection with the NTN node 504 and re-acquire latest location information of the UE 506 by performing a new location fix.

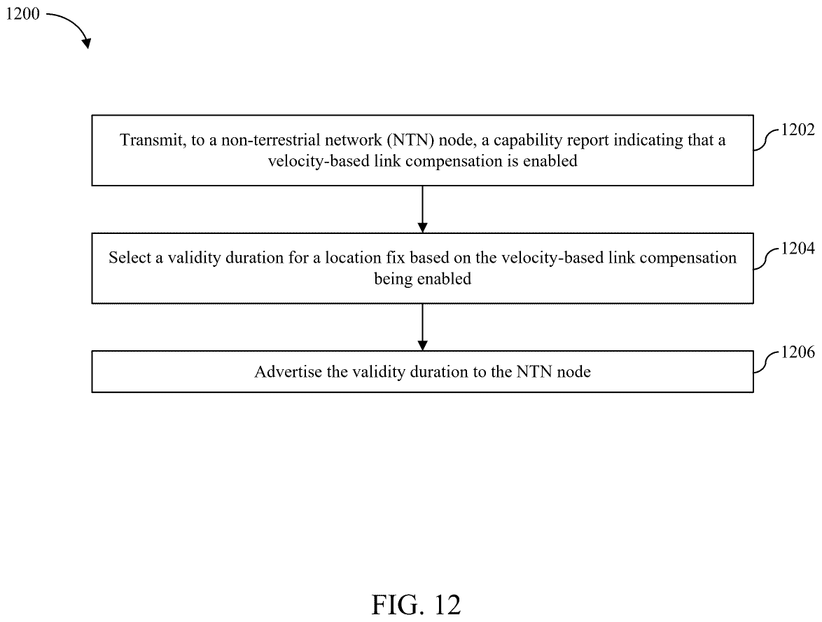

FIG. 12 is a flowchart that illustrates a method (e.g., a process) executed at a non-stationary UE to facilitate velocity-based compensation during NTN communication, in accordance with an exemplary aspect of the present disclosure. In many examples, the non-stationary UE can be the UE 106′, the UE 212, or the UE 506 described in the foregoing description of FIGS. 1-8. Referring to FIG. 12, there is shown a flowchart 1200 that illustrates exemplary operations 1202 through 1206 for performing velocity-based compensation during NTN communication. In a non-limiting example, the flowchart 1200 is explained with reference to the UE 506 and the NTN node 504 of FIGS. 5-8.

At 1202, a capability report indicating that a velocity-based link compensation is enabled may be transmitted. For example, the UE 506 may be in a non-stationary mode and may have the velocity-based link compensation capability enabled thereon. In such a scenario, the UE 506 may transmit, to the NTN node 504, the capability report indicating (or advertising) that the velocity-based link compensation is enabled on the UE 506. In some examples, the UE 506 may transmit the capability report, to the NTN node 504, in an information element of an RRC message, a parameter in a Medium Access Control (MAC) control element, or the like. Examples of the RRC message may include an RRC Connection Resume Complete message, an RRC Connection Reestablishment Complete message, an RRC Connection Setup Complete message, or the like. In several additional aspects, the UE 506 may further indicate a movement direction of the UE 506 to the NTN node 504. For example, the UE 506 may indicate the movement direction of the UE 506 to the NTN node 504 as one of the information elements, fields, or parameters in the capability report.

At 1204, a validity duration for a location fix may be selected based on the velocity-based link compensation being enabled. The selected validity duration may indicate for how long the location fix performed by the UE 506 may remain valid. In scenarios where the velocity-based link compensation is enabled on the UE 506, the selected validity duration for the location fix may be greater than a validity duration corresponding to the velocity-based link compensation being disabled on the UE 506. In other words, the velocity-based link compensation when enabled may extend a validity of the location fix, and as a result, a duration of an established connection between the UE 506 and the NTN node 504 may be prolonged or extended. In an example, the selected validity duration may be “infinity”. In additional examples, the UE 506 can select any other value as the first validity duration which is higher than a validity duration corresponding to the velocity-based link compensation being disabled on the UE 506.

At 1206, the validity duration may be advertised to the NTN node. For example, the UE 506 may advertise the selected validity duration to the NTN node 504. By advertising (or transmitting) the extended validity duration of the location fix, the UE 506 may indicate to the NTN node 504 that the velocity-based link compensation is enabled on the UE 506. In many examples, the UE 506 may advertise the selected validity duration in an information element of an RRC message, a parameter in a MAC control element, or the like. In further examples, the selected validity duration may be advertised as part of the capability report to the NTN node 504. In many aspects, the UE 506 may also advertise a remaining validity period of the location fix to the NTN node 504.

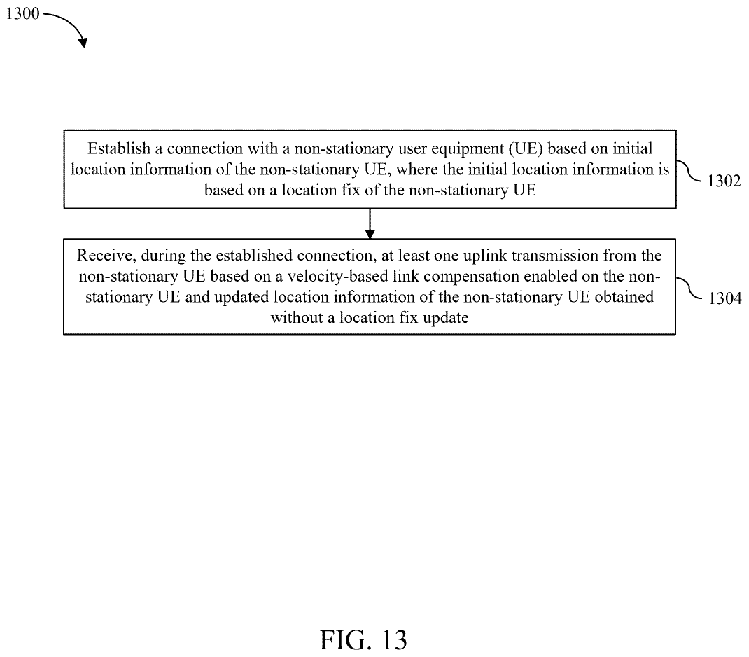

FIG. 13 is a high-level flowchart that illustrates a method (e.g., a process) executed at an NTN node that supports velocity-based compensation for NTN communication, in accordance with an exemplary aspect of the present disclosure. In many examples, the NTN node can be the NTN node 114, the NTN node 202, the NTN node/base station 302, NTN node-DU 402, or the NTN node 504 described in the foregoing description of FIGS. 1-8. Referring to FIG. 13, there is shown a flowchart 1300 that illustrates exemplary operations 1302 through 1304 for supporting velocity-based compensation. In a non-limiting example, the flowchart 1300 is explained with reference to the UE 506 and the NTN node 504 of FIGS. 5-8.

At 1302, a connection with a non-stationary UE is established based on initial location information of the non-stationary UE, where the initial location information is based on a location fix of the non-stationary UE. For example, the NTN node 504 may establish a connection with the UE 506, which is in a non-stationary mode such as a high-speed scenario. Further, the UE 506 may have velocity-based compensation enabled thereon.

At 1304, during the established connection, at least one uplink transmission from the non-stationary UE may be received based on the velocity-based link compensation enabled on the non-stationary UE and updated location information of the non-stationary UE obtained without a location fix update. Since the UE 506 is in the non-stationary mode, location information of the UE 506 may continue to change. Instead of the established connection getting disrupted for location fix updates due to the changing location of the UE 506, the NTN node 504 may receive uplink transmissions from the UE 506 that are pre-compensated by leveraging velocity information of the UE 506. Thus, the NTN node 504 may be able to communicate with the UE 506 that has the velocity-based link compensation enabled thereon for a longer duration as compared to those non-stationary UEs that have the velocity-based link compensation disabled.

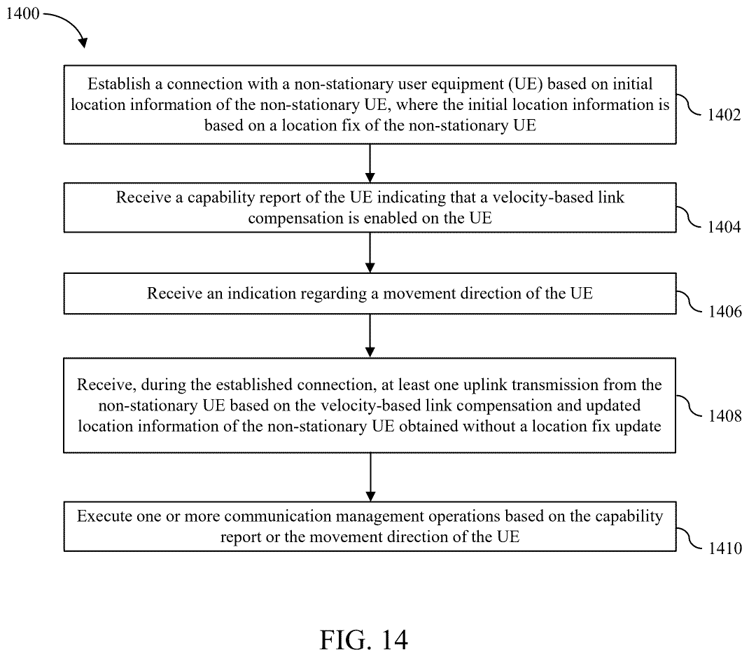

FIG. 14 is a detailed flowchart that illustrates a method (e.g., a process) executed at an NTN node that supports velocity-based compensation for NTN communication, in accordance with an exemplary aspect of the present disclosure. In many examples, the NTN node can be the NTN node 114, the NTN node 202, the NTN node/base station 302, NTN node-DU 402, or the NTN node 504 described in the foregoing description of FIGS. 1-8. Referring to FIG. 14, there is shown a flowchart 1400 that illustrates exemplary operations 1402 through 1410 for supporting velocity-based compensation. In a non-limiting example, the flowchart 1400 is explained with reference to the UE 506 and the NTN node 504 of FIGS. 5-8.

At 1402, a connection with a non-stationary UE is established based on initial location information of the non-stationary UE, where the initial location information is based on a location fix of the non-stationary UE. The UE 506 may have velocity-based compensation enabled thereon.

At 1404, a capability report of the UE indicating that the velocity-based link compensation is enabled on the UE is received. For example, the NTN node 504 may receive the capability report from the UE 506 indicating that the velocity-based link compensation is enabled on the UE 506. The NTN node 504 may receive the capability report in an information element of an RRC message, a parameter in a MAC control element, or the like. Examples of the RRC message may include an RRC Connection Resume Complete message, an RRC Connection Reestablishment Complete message, an RRC Connection Setup Complete message, or the like. In further examples, the capability report can be received in a random access preamble from the UE 506 prior to connection establishment.

At 1406, an indication regarding a movement direction of the UE may be received. The NTN node 504 may receive the indication regarding the movement direction of the UE 506. For example, the NTN node 504 may receive the indication regarding the movement direction of the UE 506 in the capability report or as a separate indication.

At 1408, during the established connection, at least one uplink transmission from the non-stationary UE may be received based on the velocity-based link compensation and updated location information of the non-stationary UE obtained without a location fix update. Since the UE 506 is in the non-stationary mode, location information of the UE 506 may keep on changing. When the velocity-based link compensation is enabled on the UE 506, instead of the established connection between the NTN node 504 and the UE 506 getting released for frequent location fix updates, the NTN node 504 may receive uplink transmissions from the UE 506 that are pre-compensated by leveraging updated location information of the non-stationary UE, which is obtained without a location fix update and based on velocity information of the UE 506. As a result a duration of the established connection between the NTN node 504 and the UE 506, which has the velocity-based link compensation enabled thereon, may be longer as compared to those non-stationary UEs that have the velocity-based link compensation disabled.

At 1410, one or more communication management operations may be executed based on the capability report or the movement direction of the UE. For example, the NTN node 504 may execute the one or more communication management operations based on the capability report indicating that the velocity-based link compensation enabled on the UE 506 and/or the movement direction of the UE 506. Examples of the one or more communication management operations may include priority grant scheduling, call reselection/handover optimization, SCS adjustment, or the like.

Priority grant scheduling may allow the NTN node 504 to prioritize a connection with a UE that has the velocity-based link compensation enabled, thus resulting in shorter connection times for such UEs. For example, based on the received capability report from the UE 506, the NTN node 504 may determine that the UE 506 has the velocity-based link compensation enabled thereon and is non-stationary, for example, in a high-speed scenario. In such scenarios, the NTN node 504 may implement priority grant scheduling to prioritize the UE 506 to ensure faster data transfer, enhancing the communication efficiency for the UE 506. Further, the NTN node 504 may leverage the movement direction indication from the UE 506 to optimize Cell Reselection and Handover. For example, as the NTN node 504 has identified the movement direction of the UE 506 based on the indication from the UE 506, the NTN node 504 can configure the UE 506 with appropriate parameters, such as next beam, a cell Evolved Absolute Radio Frequency Channel Number (EARFCN), and a Cell ID to aid in seamless reselection or handover. In other words, since the NTN node 504 manages handover by configuring the UE 506 with neighboring cells and other parameters, the NTN node 504, with the knowledge of the movement direction of the UE 506, can select one or more neighboring cells for the UE 506 to perform measurements, specifically in the movement direction of the UE 506. Additionally, the NTN node 504 can adjust the SCS to address issues such as inter-carrier interference (ICI) and timing misalignment. For example, in high-speed scenarios, the NTN node 504 may increase SCS to increase the separation between sub-carriers in the frequency domain, reducing sensitivity to Doppler shifts.

Additionally, higher SCS results in shorter symbol durations, which are less affected by Doppler-induced phase distortion, thus enhancing the overall signal quality. The NTN node 504 can adjust the SCS dynamically based on the Doppler conditions, as reported by the UE's capability. Thus, by using SCS adjustment, the NTN node 504 can improve the quality and reliability of the communication link, particularly in high-speed or dynamic environments.

Techniques consistent with the present disclosure provide, among other features, systems, and methods for extending location fix validity for NTN communication.

Aspects in the present disclosure enable a non-stationary UE, which has established a connection with an NTN node based on a location fix performed at a first time instance, to self-update corresponding location information at subsequent time instances (e.g., periodically), without location fix updates, by leveraging velocity information of the UE and initial location information from the location fix at the first time instance. Thus, in scenarios where the UE is not configured for simultaneously performing a location fix while communicating with the NTN node, the aspects of the present disclosure allow the UE to maintain a continuous connection with the NTN node for a longer duration, minimizing disruptions and reducing power consumption. As a result, connection reliability may be improved, battery life may be extended, and overall system efficiency may be optimized. Further, the information, such as location fix validity, movement direction, velocity-based compensation capability, or the like, advertised by such a UE to the NTN node may allow the NTN node to optimize priority grant scheduling, call reselection/handover optimization, SCS adjustment, etc., which may improve overall NTN system efficiency.

Some implementation examples are described in the following numbered aspects:

Aspect 1: A method for wireless communication at a user equipment (UE), the method comprising acquiring initial location information of the UE from a location fix at a first time instance, obtaining, based on the initial location information of the UE and velocity information of the UE at the first time instance, updated location information of the UE at a second time instance, without a location fix update, and applying, based at least in part on the updated location information, one or more link compensations to an uplink transmission of the UE directed to a non-terrestrial network node.

Aspect 2: The method of aspect 1, wherein the one or more link compensations comprise at least one of a timing advance adjustment or a Doppler adjustment.

Aspect 3: The method of any of aspects 1 through 2, further comprising establishing a connection with the NTN node based on the acquired initial location information from the location fix.

Aspect 4: The method of aspect 3, further comprising applying the one or more link compensations to the uplink transmission while the UE is in a connected mode for the established connection with the NTN node.

Aspect 5: The method of any of aspects 1 through 4, further comprising determining the velocity information of the UE at the first time instance, wherein the ULE is in a non-stationary mode.

Aspect 6: The method of aspect 5, wherein the determination of the velocity information of the UE is based on the location fix at the first time instance.

Aspect 7: The method of any of aspects 5 through 6, further comprising acquiring motion sensor data associated with the UE at the first time instance, wherein the determination of the velocity information of the UE at the first time instance is based on the acquired motion sensor data.

Aspect 8: The method of aspect 1, further comprising periodically obtaining, based on the velocity information of the UE and the initial location information at the first time instance, a plurality of updated location information of the UE at a plurality of time instances, respectively, without the location fix update. The plurality of time instances occurs after the first time instance and comprises the second time instance, and the plurality of updated location information comprises the updated location information at the second time instance.

Aspect 9: The method of any of aspects 1 through 8, further comprising determining a relative velocity between the UE and the NTN node based on the velocity information of the UE and velocity information of the NTN node, and obtaining an indication at the second time instance that the relative velocity is greater than or equal to a threshold relative velocity value, wherein the application of the one or more link compensations to the uplink transmission is further based on the indication that the relative velocity is greater than or equal to the threshold relative velocity value.

Aspect 10: The method of any of aspects 1 through 9, wherein the velocity information indicates a movement direction of the UE.

Aspect 11: The method of aspect 10, further comprising obtaining an indication that a current movement direction of the UE at the second time instance is within an allowable threshold of deviation from the movement direction indicated by the velocity information, wherein the obtaining the updated location information at the second time instance without the location fix update is further based on the indication that the current movement direction of the UE at the second time instance is within the allowable threshold of deviation.

Aspect 12: The method of any of aspects 10 through 11, further comprising obtaining an indication that a current movement direction of the UE at a third time instance is outside an allowable threshold of deviation from the movement direction indicated by the velocity information, wherein the third time instance occurs after the second time instance, and release a connection with the NTN node based on the indication that the current movement direction of the UE at the third time instance is outside the allowable threshold of deviation.

Aspect 13: The method of any of aspects 1 through 12, further comprising transmitting, to the NTN node, a capability report indicating that a velocity-based link compensation is enabled on the UE.

Aspect 14: The method of aspect 13, wherein the application of the one or more link compensations to the uplink transmission is further based on the velocity-based link compensation being enabled on the UE.

Aspect 15: The method of any of aspects 13 through 14, wherein the capability report further indicates a movement direction of the UE at the first time instance to the NTN node.

Aspect 16: The method of any of aspects 13 through 15, wherein the transmitting of the capability report further comprises transmitting, to the NTN node, at least one of an information element of a Radio Resource Control message or a parameter in a Medium Access Control (MAC) control element that includes the capability report.

Aspect 17: The method of any of aspects 13 through 16, further comprising selecting a first validity duration for the location fix based on the velocity-based link compensation being enabled, and advertising the selected first validity duration for the location fix to the NTN node, wherein the second time instance occurs after the first time instance and prior to an expiration of the first validity duration.

Aspect 18: The method of aspect 17, wherein the selected first validity duration is greater than a second validity duration corresponding to the velocity-based link compensation being disabled.

Aspect 19: A method of wireless communication performed by an NTN node, the method comprising: establishing a connection with a non-stationary UE based on initial location information of the non-stationary UE, wherein the non-stationary UE has a velocity-based link compensation enabled, and the initial location information is based on a location fix of the non-stationary UE; and receiving, during the established connection, at least one uplink transmission from the non-stationary UE based on the velocity-based link compensation and updated location information of the non-stationary UE obtained without a location fix update.

Aspect 20: The method of aspect 19, further comprising receiving, from the non-stationary UE, a capability report indicating that the velocity-based link compensation is enabled on the non-stationary UE.

Aspect 21: The method of aspect 20, wherein the capability report further indicates a movement direction of the non-stationary UE to the NTN node.

Aspect 22: The method of any of aspects 20 through 21, wherein the reception of the capability report comprises receiving at least one of an information element of a Radio Resource Control message or a parameter in a Medium Access Control (MAC) control element that includes the capability report.

Aspect 23: The method of any of aspects 20 through 22, further comprising receiving, from the non-stationary UE, a first validity duration for the location fix, wherein the first validity duration is greater than a second validity duration corresponding to the velocity-based link compensation being disabled on the non-stationary UE.

Aspect 24: An apparatus for wireless communications at a UE, comprising one or more memories and one or more processors coupled to the one or more memories, the one or more processors individually or collectively configured to cause the apparatus to perform a method of any of aspects 1 through 18.

Aspect 25: An apparatus for wireless communications at a UE, comprising at least one means for performing a method of any of aspects 1 through 18.

Aspect 26: A non-transitory computer-readable medium storing code for wireless communications at a UE, the code comprising instructions executable by a processor to perform a method of any of aspects 1 through 18.

Aspect 27: An NTN node for wireless communications, the NTN node comprising one or more memories and one or more processors coupled to the one or more memories, the one or more processors individually or collectively configured to cause the NTN node to perform a method of any of aspects 19 through 23.

Aspect 28: An NTN node for wireless communications, comprising at least one means for performing a method of any of aspects 19 through 23.

Aspect 29: A non-transitory computer-readable medium storing code for wireless communications at an NTN node, the code comprising instructions executable by a processor to perform a method of any of aspects 19 through 23.

It is understood that the specific order or hierarchy of steps in the processes disclosed is an illustration of exemplary approaches. Based on design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

The aforementioned description is provided to enable any person skilled in the art to practice the various aspects described herein. Various modifications to these aspects will be readily apparent to those skilled in the art, and the generic principles defined herein may be applied to further aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. No claim element is to be construed as a means plus function unless the element is expressly recited using the phrase “means for.” Further, unless stated otherwise, terms such as “first” and “second” are used to arbitrarily distinguish between the elements such terms describe. Thus, these terms are not necessarily intended to indicate temporal or other prioritization of such elements. The term “coupled” may refer to at least one of direct or indirect coupling that may not necessarily be by way of mechanical or any physical means. Further, a system or method that “comprises”, “has”, or “includes” one or more elements possesses those one or more elements but is not limited to possessing only those one or more elements.

What is claimed is:

1. An apparatus for wireless communication at a user equipment (UE), the apparatus comprising:
one or more memories; and
one or more processors coupled to the one or more memories, the one or more processors individually or collectively configured to cause the apparatus to:
acquire initial location information of the UE from a location fix at a first time instance;
obtain, based on the initial location information of the UE and velocity information of the UE at the first time instance, updated location information of the UE at a second time instance, without a location fix update; and
apply, based at least in part on the updated location information, one or more link compensations to an uplink transmission of the UE directed to a non-terrestrial network node.

2. The apparatus of claim 1, wherein the one or more link compensations comprise at least one of a timing advance adjustment or a Doppler adjustment.

3. The apparatus of claim 1, wherein the one or more processors are individually or collectively further configured to cause the apparatus to establish a connection with the NTN node based on the acquired initial location information from the location fix.

4. The apparatus of claim 3, wherein the one or more processors are individually or collectively further configured to cause the apparatus to apply the one or more link compensations to the uplink transmission while the UE is in a connected mode for the established connection with the NTN node.

5. The apparatus of claim 1, wherein the one or more processors are individually or collectively further configured to cause the apparatus to determine the velocity information of the UE at the first time instance, wherein the UE is in a non-stationary mode.

6. The apparatus of claim 5, wherein the determination of the velocity information of the UE is based on the location fix at the first time instance.

7. The apparatus of claim 5, wherein the one or more processors are individually or collectively further configured to cause the apparatus to:
acquire motion sensor data associated with the UE at the first time instance, wherein the determination of the velocity information of the UE at the first time instance is based on the acquired motion sensor data.

8. The apparatus of claim 1, wherein the one or more processors are individually or collectively further configured to cause the apparatus to:
periodically obtain, based on the velocity information of the UE and the initial location information at the first time instance, a plurality of updated location information of the UE at a plurality of time instances, respectively, without the location fix update, wherein
the plurality of time instances occurs after the first time instance and comprises the second time instance, and
the plurality of updated location information comprises the updated location information at the second time instance.

9. The apparatus of claim 1, wherein the one or more processors are individually or collectively further configured to cause the apparatus to:
determine a relative velocity between the UE and the NTN node based on the velocity information of the UE and velocity information of the NTN node; and
obtain an indication at the second time instance that the relative velocity is greater than or equal to a threshold relative velocity value, wherein the application of the one or more link compensations to the uplink transmission is further based on the indication that the relative velocity is greater than or equal to the threshold relative velocity value.

10. The apparatus of claim 1, wherein the velocity information indicates a movement direction of the UE.

11. The apparatus of claim 10, wherein the one or more processors are individually or collectively further configured to cause the apparatus to:
obtain an indication that a current movement direction of the UE at the second time instance is within an allowable threshold of deviation from the movement direction indicated by the velocity information, wherein the obtaining the updated location information at the second time instance without the location fix update is further based on the indication that the current movement direction of the UE at the second time instance is within the allowable threshold of deviation.

12. The apparatus of claim 10, wherein the one or more processors are individually or collectively further configured to cause the apparatus to:
obtain an indication that a current movement direction of the UE at a third time instance is outside an allowable threshold of deviation from the movement direction indicated by the velocity information, wherein the third time instance occurs after the second time instance; and
release a connection with the NTN node based on the indication that the current movement direction of the UE at the third time instance is outside the allowable threshold of deviation.

13. The apparatus of claim 1, wherein the one or more processors are individually or collectively further configured to cause the apparatus to transmit, to the NTN node, a capability report indicating that a velocity-based link compensation is enabled on the UE.

14. The apparatus of claim 13, wherein the application of the one or more link compensations to the uplink transmission is further based on the velocity-based link compensation being enabled on the UE.

15. The apparatus of claim 13, wherein the capability report further indicates a movement direction of the UE at the first time instance to the NTN node.

16. The apparatus of claim 13, wherein to transmit the capability report, the one or more processors are individually or collectively further configured to cause the apparatus to transmit, to the NTN node, at least one of an information element of a Radio Resource Control message or a parameter in a Medium Access Control (MAC) control element that includes the capability report.

17. The apparatus of claim 13, wherein the one or more processors are individually or collectively further configured to cause the apparatus to:
select a first validity duration for the location fix based on the velocity-based link compensation being enabled; and
advertise the selected first validity duration for the location fix to the NTN node, wherein the second time instance occurs after the first time instance and prior to an expiration of the first validity duration.

18. The apparatus of claim 17, wherein the selected first validity duration is greater than a second validity duration corresponding to the velocity-based link compensation being disabled.

19. A method of wireless communication performed by a user equipment (UE), the method comprising:
acquiring initial location information of the UE from a location fix at a first time instance;
obtaining, based on the initial location information of the UE and velocity information of the UE at the first time instance, updated location information of the UE at a second time instance, without a location fix update; and
applying, based on the updated location information, one or more link compensations to an uplink transmission of the UE directed to a non-terrestrial network (NTN) node.

20. A non-terrestrial network (NTN) node for wireless communication, the NTN node comprising:
one or more memories; and
one or more processors coupled to the one or more memories, the one or more processors individually or collectively configured to cause the NTN node to:
establish a connection with a non-stationary user equipment (UE) based on initial location information of the non-stationary UE, wherein the non-stationary UE has a velocity-based link compensation enabled, and the initial location information is based on a location fix of the non-stationary UE; and
receive, during the established connection, at least one uplink transmission from the non-stationary UE based on the velocity-based link compensation and updated location information of the non-stationary UE obtained without a location fix update.
